(19) United States
(12) Patent Application Publication
(10) Pub. No.: US 2026/0362253 A1
(43) Pub. Date: Nov. 12, 2026

(54) TIMING ADVANCE INDICATIONS FOR CANDIDATE SERVING CELLS

(71) Applicant: QUALCOMM INCORPORATED, San Diego, CA (US)

(72) Inventors: Fang YUAN, Beijing (CN); Yan ZHOU, San Diego, CA (US); Tao LUO, San Diego, CA (US)

(21) Appl. No.: 19/102,049

(22) PCT Filed: Oct. 24, 2023
(86) PCT No.: PCT/CN2023/126164

§ 371 Date: Feb. 7, 2025

(30) Foreign Application Priority Data
Nov. 4, 2022 (WO) PCT/CN2022/129783
Nov. 4, 2022 (WO) PCT/CN2022/129799
Nov. 4, 2022 (WO) PCT/CN2022/129811

(51) Int. Cl. H04W 36/00; H04W 36/32; H04W 56/00

(52) U.S. Cl. CPC H04W 36/0072; H04W 36/00835; H04W 36/324; H04W 56/001

(57) ABSTRACT

Various aspects of the present disclosure generally relate to wireless communication. In some aspects, a user equipment (UE) may receive a timing advance (TA) indication associated with a candidate serving cell configured for layer 1/layer 2 (L1/L2) mobility. The UE may receive, with the TA indication, an L1 message or an L2 message instructing the UE to switch to the candidate serving cell. Accordingly, the UE may communicate with the candidate serving cell based on the L1 message or the L2 message. Numerous other aspects are described.

### CROSS-REFERENCE TO RELATED APPLICATION

This Patent Application claims priority to Patent Cooperation Treaty (PCT) Application Nos. PCT/CN2022/129799, PCT/CN2022/129811, and PCT/CN 2022/129783, filed on Nov. 4, 2022, entitled “TIMING ADVANCE INDICATIONS FOR CANDIDATE SERVING CELLS,” “MAXIMUM QUANTITIES OF TIMING ADVANCE GROUPS,” and “DOWNLINK REFERENCE TIMING FOR DETERMINING A TIMING ADVANCE FOR A CANDIDATE CELL,” respectively, and assigned to the assignee hereof. The disclosures of the prior Applications are considered part of and are incorporated by reference in this Patent Application.

### FIELD OF THE DISCLOSURE

Aspects of the present disclosure generally relate to wireless communication and to techniques and apparatuses for timing advance indications for candidate serving cells.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include one or more memories and one or more processors coupled to the one or more memories. The one or more processors, individually or in any combination, may be operable to cause the apparatus to receive a timing advance (TA) indication associated with a candidate serving cell configured for layer 1/layer 2 (L1/L2) mobility. The one or more processors, individually or in any combination, may be operable to cause the apparatus to receive, with the TA indication, an L1 message or an L2 message instructing the UE to switch to the candidate serving cell. The one or more processors, individually or in any combination, may be operable to cause the apparatus to communicate with the candidate serving cell based on the L1 message or the L2 message.

Some aspects described herein relate to an apparatus for wireless communication at a network node. The apparatus may include one or more memories and one or more processors coupled to the one or more memories. The one or more processors, individually or in any combination, may be operable to cause the apparatus to transmit a TA indication associated with a candidate serving cell configured for L1/L2 mobility. The one or more processors, individually or in any combination, may be operable to cause the apparatus to transmit, with the TA indication, an L1 message or an L2 message instructing a UE to switch to the candidate serving cell.

Some aspects described herein relate to an apparatus for wireless communication at a UE. The apparatus may include one or more memories and one or more processors coupled to the one or more memories. The one or more processors, individually or in any combination, may be operable to cause the apparatus to receive an L1 message or an L2 message instructing the UE to switch to a candidate serving cell. The one or more processors, individually or in any combination, may be operable to cause the apparatus to receive, after the L1 message or the L2 message, a TA indication associated with the candidate serving cell. The one or more processors, individually or in any combination, may be operable to cause the apparatus to communicate with the candidate serving cell based on the TA indication.

Some aspects described herein relate to an apparatus for wireless communication at a network node. The apparatus may include one or more memories and one or more processors coupled to the one or more memories. The one or more processors, individually or in any combination, may be operable to cause the apparatus to transmit a TA indication associated with a candidate serving cell configured for L1/L2 mobility after an L1 message or an L2 message instructing a UE to switch to the candidate serving cell. The one or more processors, individually or in any combination, may be operable to cause the apparatus to communicate with the UE based on the TA indication.

Some aspects described herein relate to a method of wireless communication performed by a UE. The method may include receiving a TA indication associated with a candidate serving cell configured for L1/L2 mobility. The method may include receiving, with the TA indication, an L1 message or an L2 message instructing the UE to switch to the candidate serving cell. The method may include communicating with the candidate serving cell based on the L1 message or the L2 message.

Some aspects described herein relate to a method of wireless communication performed by a network node. The method may include transmitting a TA indication associated with a candidate serving cell configured for L1/L2 mobility. The method may include transmitting, with the TA indication, an L1 message or an L2 message instructing a UE to switch to the candidate serving cell.

Some aspects described herein relate to a method of wireless communication performed by a UE. The method may include receiving an L1 message or an L2 message instructing the UE to switch to a candidate serving cell. The method may include receiving, after the L1 message or the L2 message, a TA indication associated with the candidate serving cell. The method may include communicating with the candidate serving cell based on the TA indication.

Some aspects described herein relate to a method of wireless communication performed by a network node. The method may include transmitting a TA indication associated with a candidate serving cell configured for L1/L2 mobility after an L1 message or an L2 message instructing a UE to switch to the candidate serving cell. The method may include communicating with the UE based on the TA indication.

Some aspects described herein relate to a non-transitory computer-readable medium that stores a set of instructions for wireless communication by a UE. The set of instructions, when executed by one or more processors of the UE, may cause the UE to receive a TA indication associated with a candidate serving cell configured for L1/L2 mobility. The set of instructions, when executed by one or more processors of the UE, may cause the UE to receive, with the TA indication, an L1 message or an L2 message instructing the UE to switch to the candidate serving cell. The set of instructions, when executed by one or more processors of the UE, may cause the UE to communicate with the candidate serving cell based on the L1 message or the L2 message.

Some aspects described herein relate to a non-transitory computer-readable medium that stores a set of instructions for wireless communication by a network node. The set of instructions, when executed by one or more processors of the network node, may cause the network node to transmit a TA indication associated with a candidate serving cell configured for L1/L2 mobility. The set of instructions, when executed by one or more processors of the network node, may cause the network node to transmit, with the TA indication, an L1 message or an L2 message instructing a UE to switch to the candidate serving cell.

Some aspects described herein relate to a non-transitory computer-readable medium that stores a set of instructions for wireless communication by a UE. The set of instructions, when executed by one or more processors of the UE, may cause the UE to receive an L1 message or a L2 message instructing the UE to switch to a candidate serving cell. The set of instructions, when executed by one or more processors of the UE, may cause the UE to receive, after the L1 message or the L2 message, a TA indication associated with the candidate serving cell. The set of instructions, when executed by one or more processors of the UE, may cause the UE to communicate with the candidate serving cell based on the TA indication.

Some aspects described herein relate to a non-transitory computer-readable medium that stores a set of instructions for wireless communication by a network node. The set of instructions, when executed by one or more processors of the network node, may cause the network node to transmit a TA indication associated with a candidate serving cell configured for L1/L2 mobility after an L1 message or an L2 message instructing a UE to switch to the candidate serving cell. The set of instructions, when executed by one or more processors of the network node, may cause the network node to communicate with the UE based on the TA indication.

Some aspects described herein relate to an apparatus for wireless communication. The apparatus may include means for receiving a TA indication associated with a candidate serving cell configured for L1/L2 mobility. The apparatus may include means for receiving, with the TA indication, an L1 message or an L2 message instructing the apparatus to switch to the candidate serving cell. The apparatus may include means for communicating with the candidate serving cell based on the L1 message or the L2 message.

Some aspects described herein relate to an apparatus for wireless communication. The apparatus may include means for transmitting a TA indication associated with a candidate serving cell configured for L1/L2 mobility. The apparatus may include means for transmitting, with the TA indication, an L1 message or an L2 message instructing a UE to switch to the candidate serving cell.

Some aspects described herein relate to an apparatus for wireless communication. The apparatus may include means for receiving an L1 message or an L2 message instructing the apparatus to switch to a candidate serving cell. The apparatus may include means for receiving, after the L1 message or the L2 message, a TA indication associated with the candidate serving cell. The apparatus may include means for communicating with the candidate serving cell based on the TA indication.

Some aspects described herein relate to an apparatus for wireless communication. The apparatus may include means for transmitting a TA indication associated with a candidate serving cell configured for L1/L2 mobility after an L1 message or an L2 message instructing a UE to switch to the candidate serving cell. The apparatus may include means for communicating with the UE based on the TA indication.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment in a wireless network, in accordance with the present disclosure.

FIG. 3 is a diagram illustrating an example disaggregated base station architecture, in accordance with the present disclosure.

FIG. 4 is a diagram illustrating an example of timing advances (TAs) for active and candidate serving cells, in accordance with the present disclosure.

FIG. 5 is a diagram illustrating an example associated with providing TA indications before or with an instruction to switch to a candidate serving cell, in accordance with the present disclosure.

FIG. 6 is a diagram illustrating an example associated with providing TA indications after an instruction to switch to a candidate serving cell, in accordance with the present disclosure.

FIG. 7 is a diagram illustrating an example of timing advance groups (TAGs) for transmit-receive points, in accordance with the present disclosure.

FIG. 8 is a diagram illustrating an example associated with reporting and using maximum quantities of TAGs, in accordance with the present disclosure.

FIGS. 9, 10, 11, and 12 are diagrams illustrating examples of determining a downlink reference timing for determining an uplink timing advance for a candidate cell, in accordance with the present disclosure.

FIGS. 13, 14, 15, and 16 are diagrams illustrating example processes associated with TA indications associated with a candidate serving cell, in accordance with the present disclosure.

FIGS. 17, 18, 19, and 20 are diagrams illustrating example processes associated with reporting and using maximum quantities of TAGs, in accordance with the present disclosure.

FIG. 21 is a diagram illustrating an example process associated with determining a downlink reference timing for determining an uplink timing advance for a candidate cell, in accordance with the present disclosure.

FIGS. 22 and 23 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

Various aspects relate generally to wireless communication and more particularly to timing advance (TA) commands. Some aspects more specifically relate to providing a TA command, associated with a candidate serving cell, before or with a command to move from an active serving cell to the candidate serving cell. For example, the candidate serving cell may be associated with a layer 1/layer 2 (L1/L2) mobility configuration such that the command is included in an L1 message or an L2 message. A user equipment (UE) may thus perform a timing adjustment before communicating with the candidate serving cell. Alternatively, some aspects more specifically relate to providing a TA command, associated with a candidate serving cell, after a command to move from an active serving cell to the candidate serving cell. As a result, a UE may perform a timing adjustment after switching to the candidate serving cell.

Particular aspects of the subject matter described in this disclosure can be implemented to realize one or more of the following potential advantages. Performing a timing adjustment increases quality and reliability of uplink transmissions from a UE to a network. More specifically, providing a TA command before or with a command to switch from an active serving cell to a candidate serving cell enables the UE to perform a timing adjustment before communicating with a candidate serving cell. As a result, the UE experiences reduced latency because the UE can begin communicating with the candidate serving cell immediately after switching. Additionally, the UE experiences increased reliability and quality of communications, which conserves power and processing resources that would otherwise have been expended on retransmissions. Alternatively, providing a TA command after a command to switch from an active serving cell to a candidate serving cell enables the UE to perform a timing adjustment after switching to a candidate serving cell. Because the candidate serving cell provides the TA command, the active serving cell conserves power and processing resources that would otherwise have been expended on backhaul communications to determine a TA value associated with the candidate serving cell. Additionally, the UE experiences increased reliability and quality of communications, which conserves power and processing resources that would otherwise have been expended on retransmissions.

Various aspects relate generally to wireless communication and more particularly to timing advance groups (TAGs) for candidate serving cells. Some aspects more specifically relate to providing TAG configurations, associated with candidate serving cells, subject to a maximum quantity of TAGs. For example, the maximum quantity of TAGs may be reported by a UE, such as in a capability message. Additionally, or alternatively, the maximum quantity of TAGs may be preconfigured (e.g., according to an update in the Third Generation Partnership Project (3GPP) specifications and/or another standard). The UE may therefore limit how many TAG configurations are provided by a network. Additionally, or alternatively, some aspects more specifically relate to providing TAG configurations, associated with transmit-receive points (TRPs) of candidate serving cells, subject to a maximum quantity of TAGs per candidate serving cell. For example, the maximum quantity of TAGs per candidate serving cell may be reported by a UE, such as in a capability message. Additionally, or alternatively, the maximum quantity of TAGs per candidate serving cell may be preconfigured (e.g., according to an update in 3GPP specifications and/or another standard). The UE may therefore limit how many TAG configurations are provided by a network.

Particular aspects of the subject matter described in this disclosure can be implemented to realize one or more of the following potential advantages. Subjecting a quantity of TAG configurations to a maximum quantity of TAGs and/or a maximum quantity of TAGs per candidate serving cell reduces memory overhead at a UE. More specifically, the UE may reserve (e.g., using slab or stock allocation) a smaller amount of memory space to store the TAG configurations rather than if the UE were to be configured to receive an unlimited quantity of TAG configurations. As a result, the UE conserves power and processing resources that are used to manage a memory of the UE. Additionally, the UE reduces latency that would otherwise increase with the size of the reserved memory space to store the TAG configurations.

Various aspects described herein relate to L1/L2 mobility. Some aspects more specifically relate to determining a downlink reference timing for determining a timing advance for a candidate cell for L1/L2 mobility. In some examples, a UE may determine a downlink reference timing for a candidate cell. The UE may determine the timing advance for the candidate cell based at least in part on the downlink reference timing. The UE may determine the downlink reference timing based at least in part on one or more parameters, such as a downlink reference timing associated with an active serving cell of the UE, a non-serving cell of the UE, and/or a downlink reference signal of the candidate cell, among other examples.

Particular aspects of the subject matter described in this disclosure can be implemented to realize one or more of the following potential advantages. In some examples, by determining timing advances for candidate cells for L1/L2 mobility, the described techniques can be used to proactively generate and maintain a list of timing advances for candidate cells prior to handover of the UE. Generating and maintaining a list of timing advances for the candidate cells prior to a handover of the UE to a candidate cell enables the UE to more quickly apply a timing advance in the event of a handover to a candidate cell. This reduces latency in synchronizing timings between the UE and the candidate cell, reduces the time duration of a random access channel procedure to obtain service from the candidate cell, and/or increases communication efficiency with the candidate cell, among other examples. Moreover, this may enable increased wireless network resource usage efficiency and/or may reduce the likelihood of dropped communications between the UE and the candidate cell that might otherwise occur due to a lack of timing synchronization between the UE and the candidate cell.

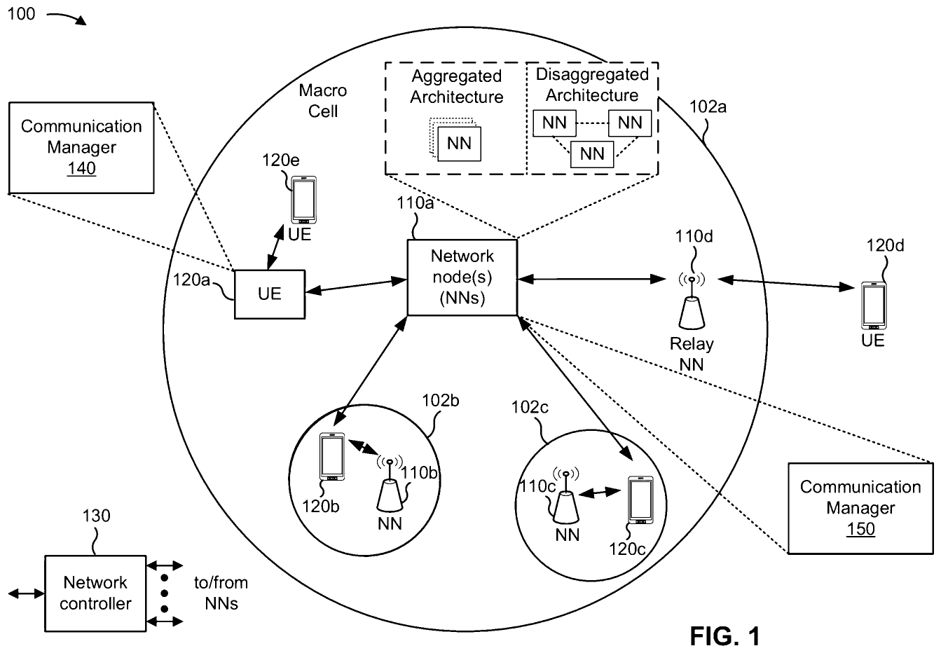

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a TRP, a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In 3GPP, the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a TA indication associated with a candidate serving cell configured for L1/L2 mobility; receive, after or with the TA indication, an L1 message or an L2 message instructing the UE 120 to switch to the candidate serving cell; and communicate with the candidate serving cell based on the L1 message or the L2 message. Alternatively, as described in more detail elsewhere herein, the communication manager 140 may receive an L1 message or an L2 message instructing the UE 120 to switch to a candidate serving cell; receive, after the L1 message or the L2 message, a TA indication associated with the candidate serving cell; and communicate with the candidate serving cell based on the TA indication. Additionally, or alternatively, as described in more detail elsewhere herein, the communication manager 140 may receive at least a first configuration for at least a first TAG including an active serving cell for the UE 120 and may receive one or more additional configurations for one or more additional TAGs including one or more candidate serving cells for the UE based on a maximum quantity of TAGs and/or based on a maximum quantity of TAGs per candidate serving cell. Additionally, or alternatively, as described in more detail elsewhere herein, the communication manager 140 may determine a downlink reference timing for a candidate cell; and determine, based at least in part on the downlink reference timing, an uplink timing advance for the candidate cell, wherein the uplink timing advance is for L1/L2 based mobility. Additionally, or alternatively, the communication manager 140 may perform one or more other operations described herein.

In some aspects, the network node 110 may include a communication manager 150. As described in more detail elsewhere herein, the communication manager 150 may transmit a TA indication associated with a candidate serving cell configured for L1/L2 mobility and transmit, after or with the TA indication, an L1 message or an L2 message instructing a UE (e.g., the UE 120) to switch to the candidate serving cell. Alternatively, as described in more detail elsewhere herein, the communication manager 150 may transmit a TA indication associated with a candidate serving cell configured for L1/L2 mobility after an L1 message or an L2 message instructing a UE (e.g., the UE 120) to switch to the candidate serving cell and communicate with the UE 120 based on the TA indication. Additionally, or alternatively, as described in more detail elsewhere herein, the communication manager 150 may transmit at least a first configuration for at least a first TAG including an active serving cell for a UE (e.g., the UE 120) and may transmit one or more additional configurations for one or more additional TAGs including one or more candidate serving cells for the UE based on a maximum quantity of TAGs and/or based on a maximum quantity of TAGs per candidate serving cell. Additionally, or alternatively, the communication manager 150 may perform one or more other operations described herein.

As indicated above, FIG. 1 is provided as an example. Other examples may differ from what is described with regard to FIG. 1.

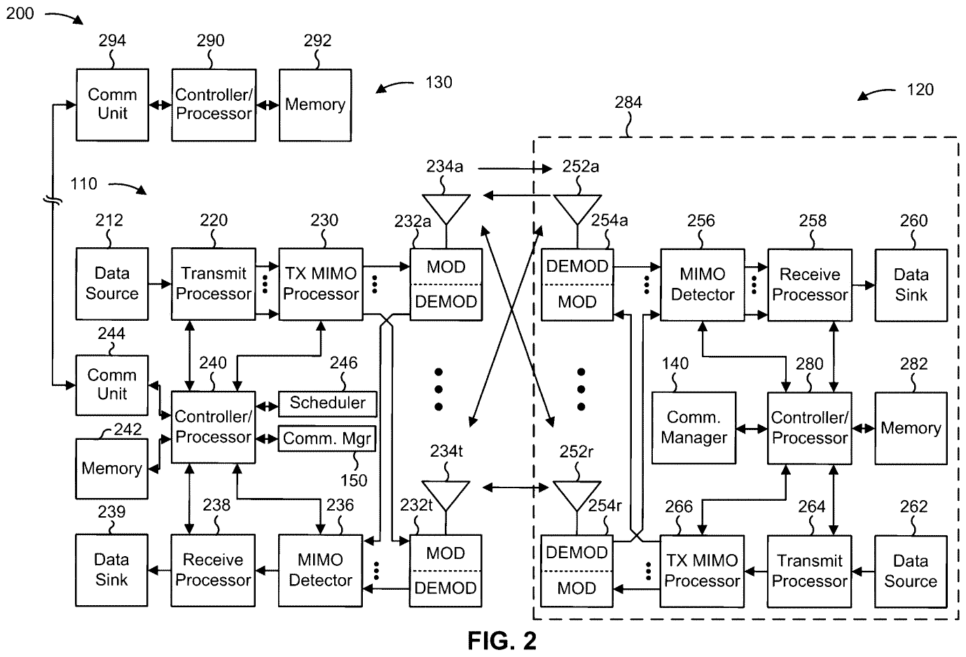

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254 a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

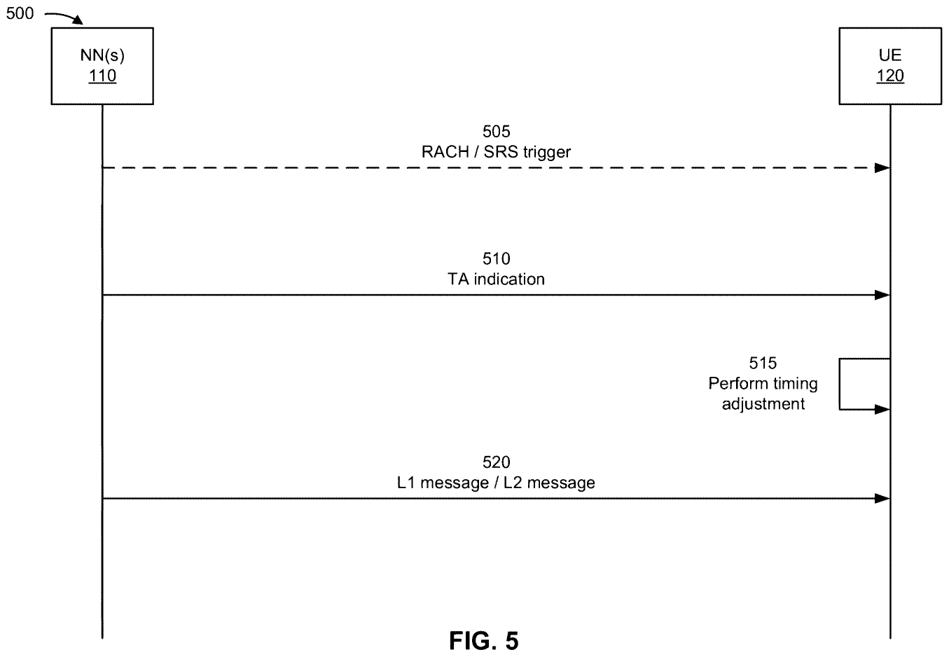

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-23).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-23).

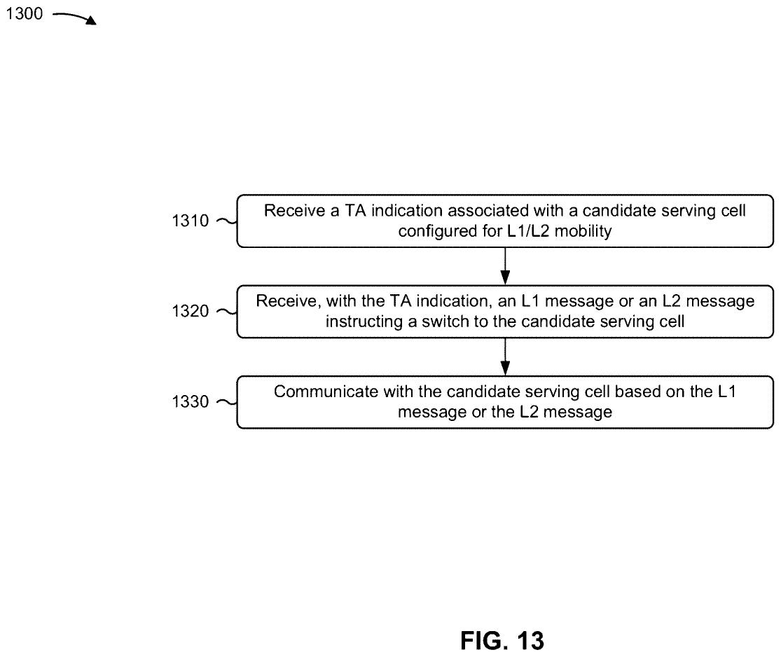

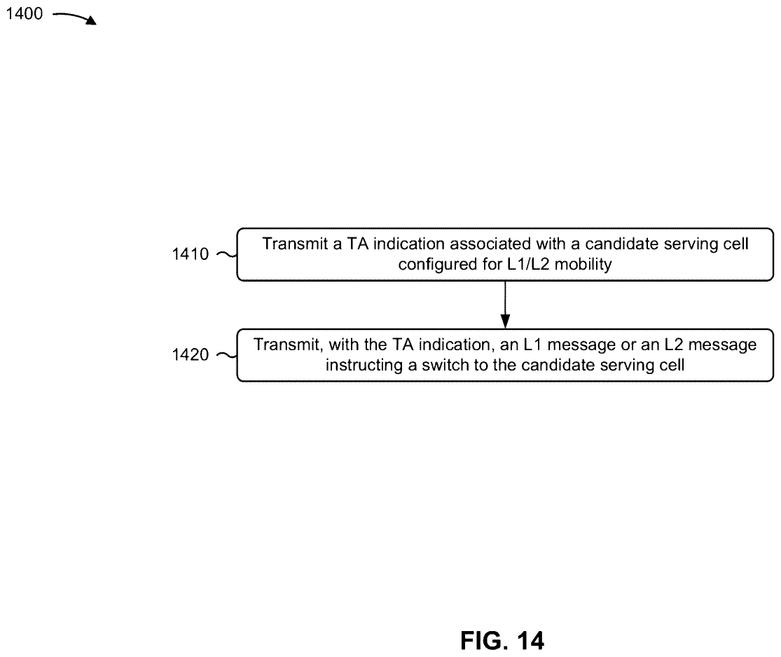

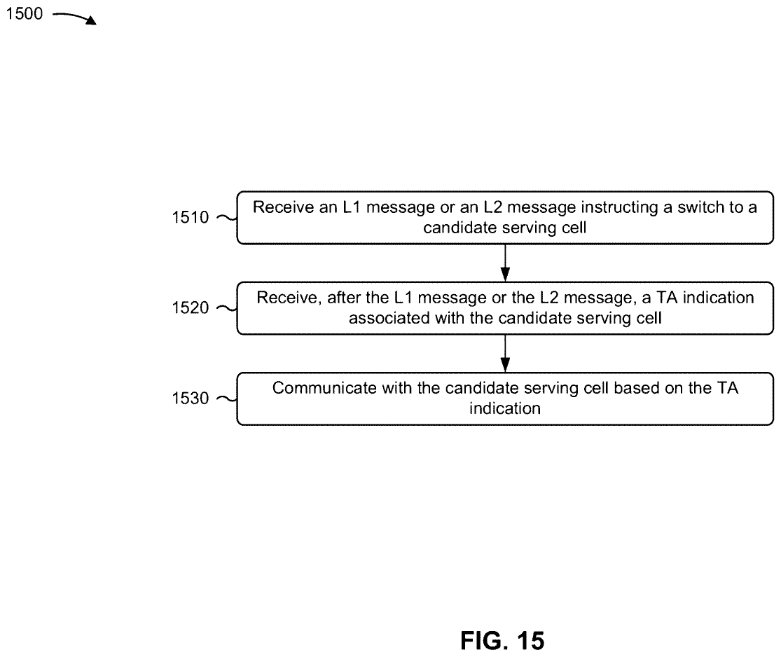

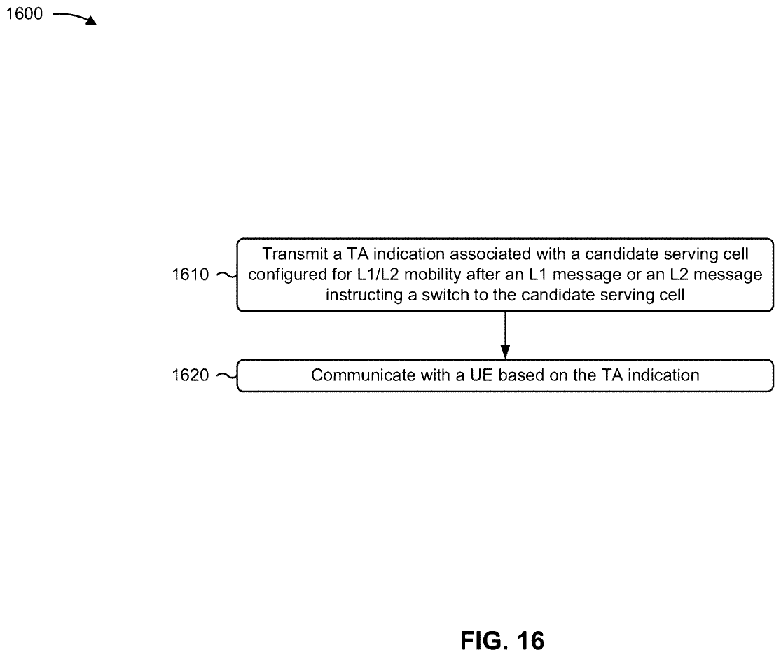

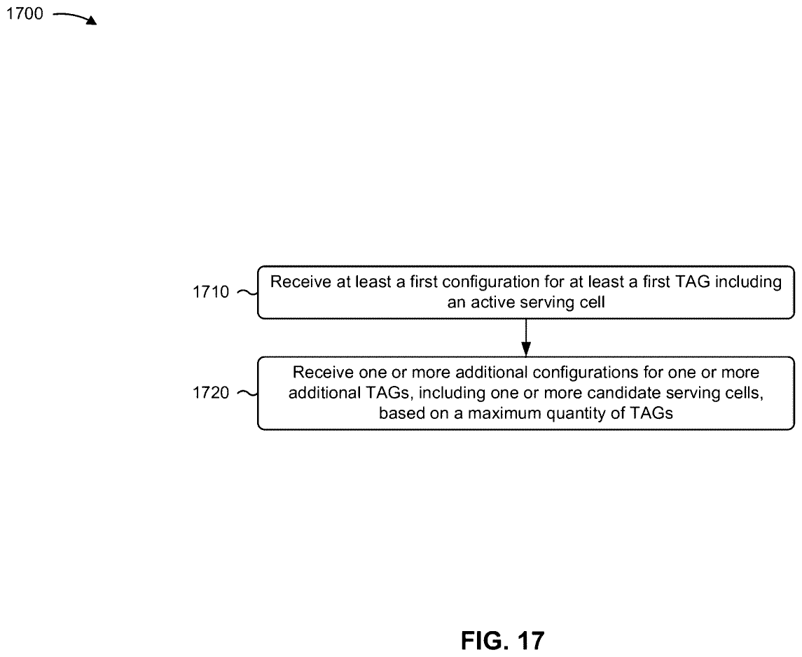

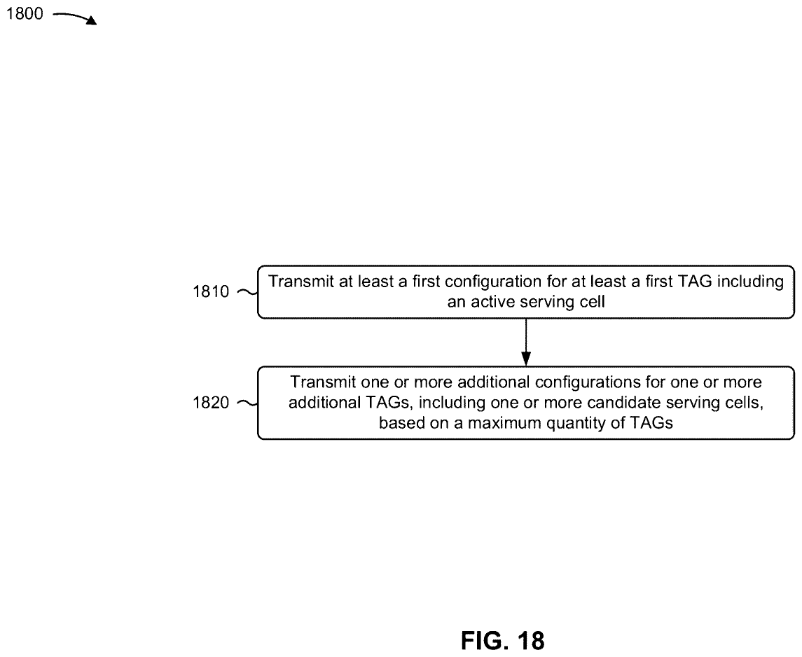

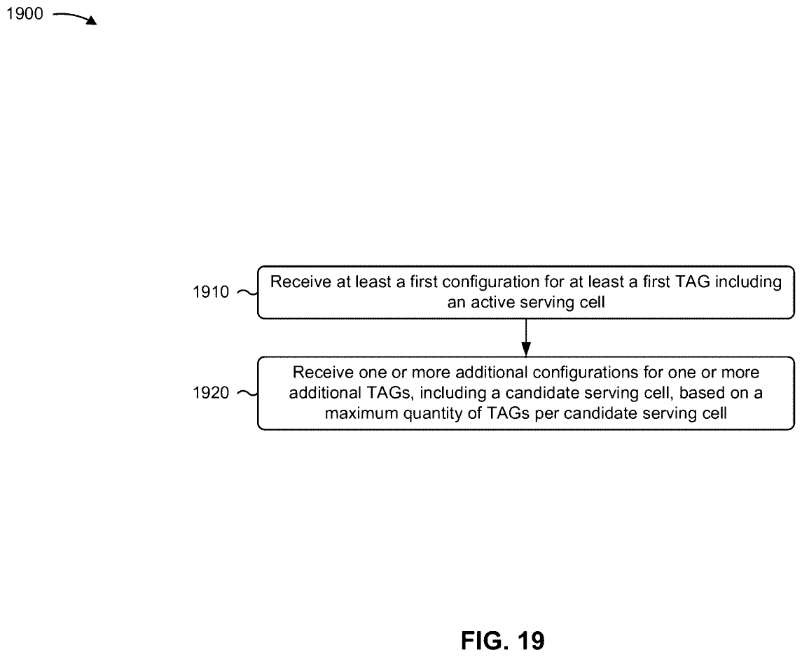

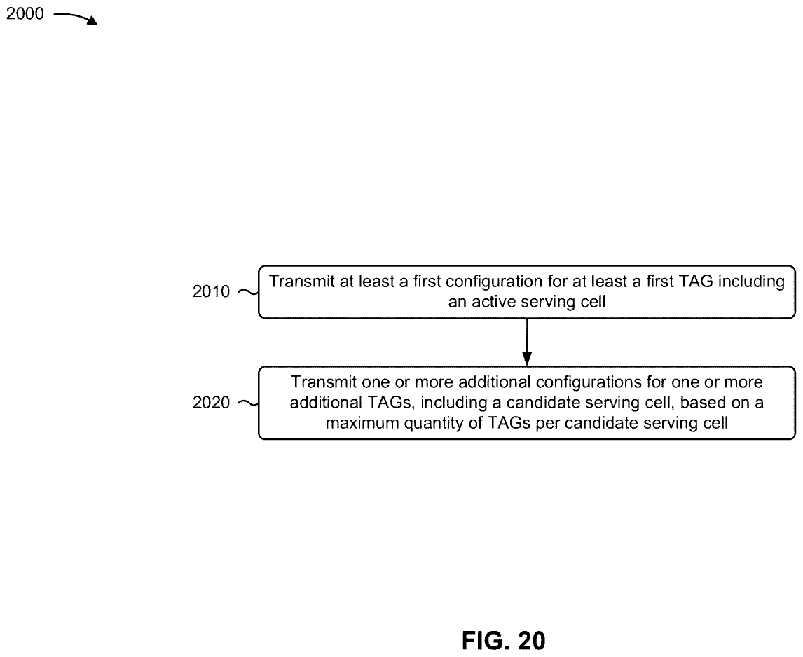

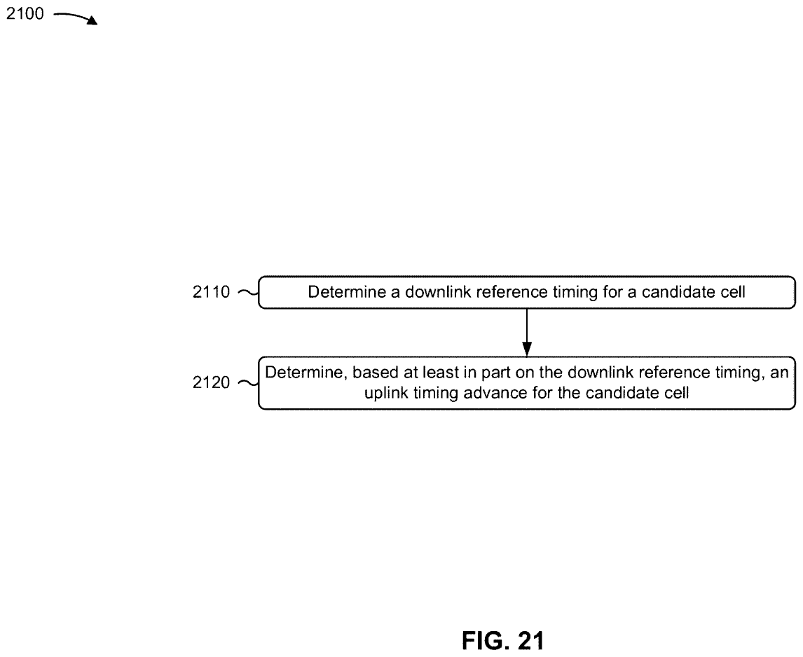

The controller/processor 240 of the network node 110, the controller/processor 280 of the UE 120, and/or any other component(s) of FIG. 2 may perform one or more techniques associated with TA indications for candidate serving cells, as described in more detail elsewhere herein. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, process 1500 of FIG. 15, process 1600 of FIG. 16, process 1700 of FIG. 17, process 1800 of FIG. 18, process 1900 of FIG. 19, process 2000 of FIG. 20, process 2100 of FIG. 21, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, process 1500 of FIG. 15, process 1600 of FIG. 16, process 1700 of FIG. 17, process 1800 of FIG. 18, process 1900 of FIG. 19, process 2000 of FIG. 20, process 2100 of FIG. 21, and/or other processes as described herein. In some examples, executing instructions may include running the instructions, converting the instructions, compiling the instructions, and/or interpreting the instructions, among other examples.

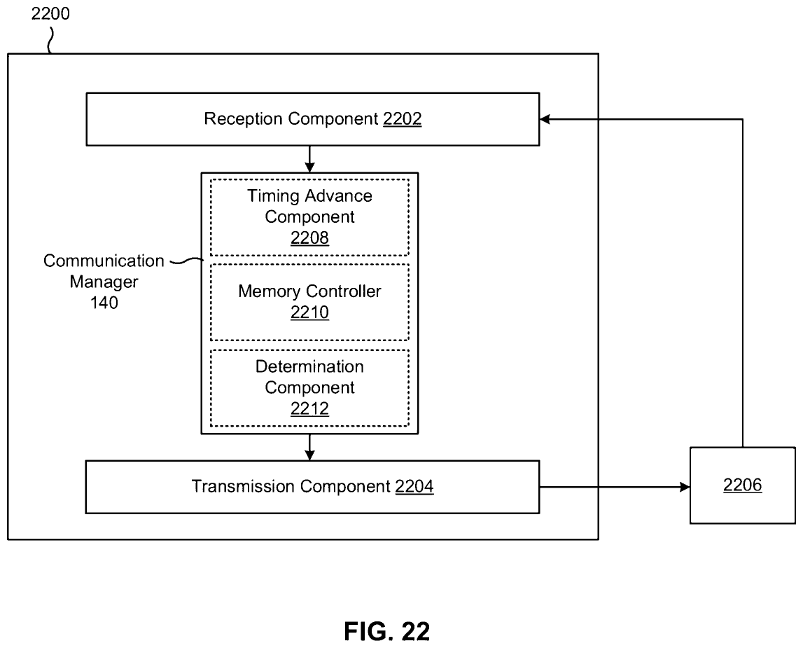

In some aspects, a UE (e.g., the UE 120 and/or apparatus 2200 of FIG. 22) may include means for receiving a TA indication associated with a candidate serving cell configured for L1/L2 mobility; means for receiving, after or with the TA indication, an L1 message or an L2 message instructing the UE to switch to the candidate serving cell; and/or means for communicating with the candidate serving cell based on the L1 message or the L2 message. Alternatively, the UE may include means for receiving an L1 message or an L2 message instructing the UE to switch to a candidate serving cell; means for receiving, after the L1 message or the L2 message, a TA indication associated with the candidate serving cell; and/or means for communicating with the candidate serving cell based on the TA indication. Additionally, or alternatively, the UE may include means for receiving at least a first configuration for at least a first TAG including an active serving cell for the UE; and/or means for receiving one or more additional configurations for one or more additional TAGs including one or more candidate serving cells for the UE based on a maximum quantity of TAGs and/or based on a maximum quantity of TAGs per candidate serving cell. Additionally, or alternatively, the UE may include means for determining a downlink reference timing for a candidate cell; and/or means for determining, based at least in part on the downlink reference timing, an uplink timing advance for the candidate cell, wherein the uplink timing advance is for L1/L2 based mobility. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

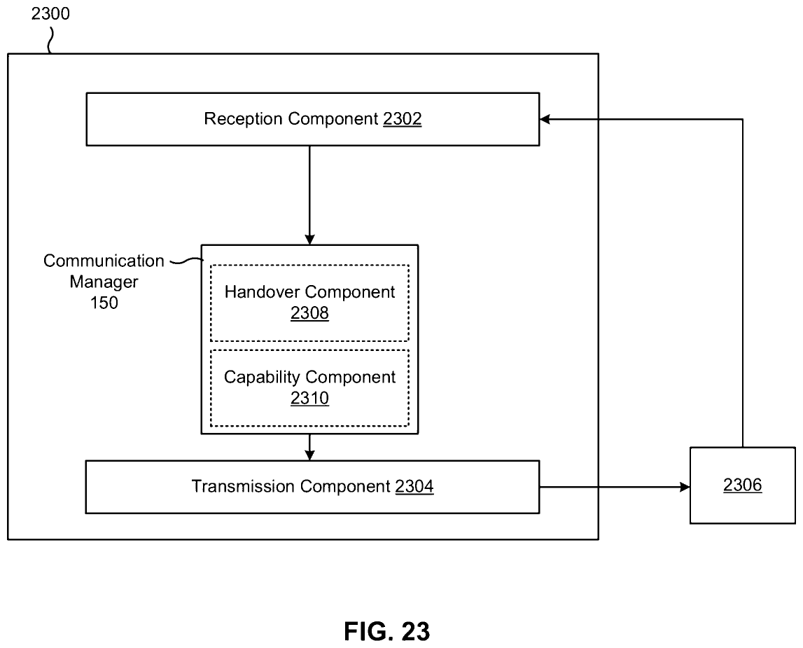

In some aspects, a network node (e.g., the network node 110, an RU 340, a DU 330, a CU 310, and/or apparatus 2300 of FIG. 23) may include means for transmitting a TA indication associated with a candidate serving cell configured for L1/L2 mobility; and/or means for transmitting, after or with the TA indication, an L1 message or an L2 message instructing a UE to switch to the candidate serving cell. Alternatively, the network node may include means for transmitting a TA indication associated with a candidate serving cell configured for L1/L2 mobility after an L1 message or an L2 message instructing a UE to switch to the candidate serving cell; and/or means for communicating with the UE based on the TA indication. Additionally, or alternatively, the network node may include means for transmitting at least a first configuration for at least a first TAG including an active serving cell for a UE; and/or means for transmitting one or more additional configurations for one or more additional TAGs including one or more candidate serving cells for the UE based on a maximum quantity of TAGs and/or based on a maximum quantity of TAGs per candidate serving cell. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

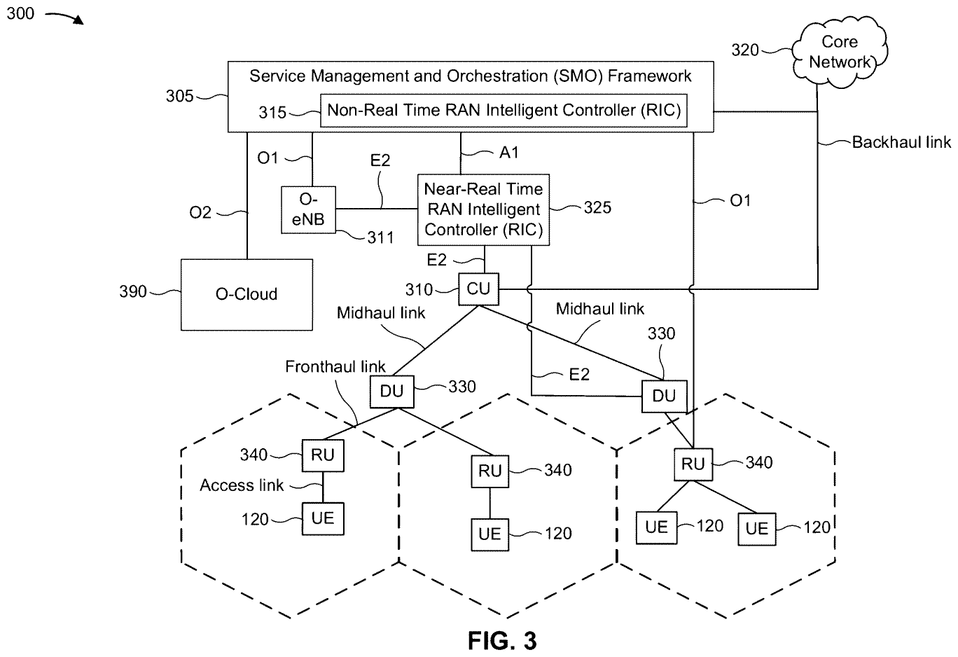

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

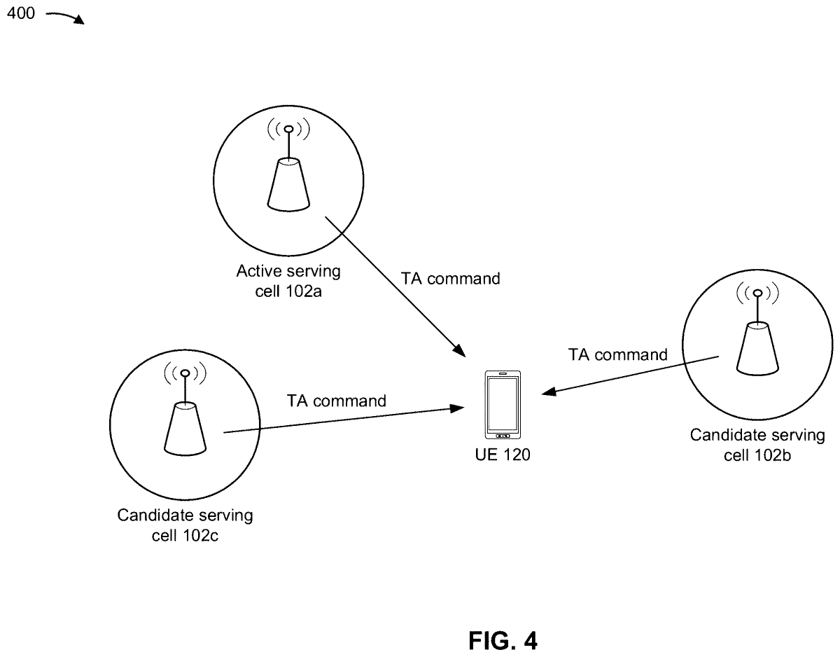

FIG. 4 is a diagram illustrating an example 400 of TAs for active and candidate serving cells, in accordance with the present disclosure. In example 400, a network may configure a UE (e.g., UE 120) with different sets of cells. Each cell may include one TRP or a group of TRPs. Additionally, or alternatively, multiple TRPs within a cell may be configured separately (e.g., for non-coherent joint transmission (NCJT)) or together (e.g., for coherent joint transmission (CJT)).

As shown in FIG. 4, the network may communicate with the UE 120 via an active serving cell 102a. The active serving cell 102a may include at least one TRP. As further shown in FIG. 4, the network may provide the UE 120 with a set of cells for L1/L2 mobility. As used herein, “layer 1” or “L1” refers to a PHY layer, “layer 2” or “L2” refers to a MAC layer, an RLC layer, a PDCP layer, and/or an SDAP layer, and “layer 1/layer 2” or “L1/L2” refers to layer 1 and/or layer 2. The network may indicate the set of cells in an RRC message including an 1112MobilityConfig data structure (e.g., as defined in 3GPP specifications and/or another standard). In example 400, the set of cells includes a candidate serving cell 102b and a candidate serving cell 102c (e.g., each including at least one TRP). Other examples may include one candidate serving cell or additional candidate serving cells (e.g., three candidate serving cells, four candidate serving cells, and so on).

Each serving cell may be associated with a timing advance group (TAG). For example, the active serving cell 102a may be associated with a first TAG, the candidate serving cell 102b may be associated with a second TAG, and the candidate serving cell 102 c may be associated with a third TAG. Accordingly, in example 400, the active serving cell 102a, the candidate serving cell 102b, and the candidate serving cell 102c may transmit different TA commands (e.g., corresponding to the different TAGs). Although example 400 is described with one cell in each TAG, other examples may include multiple cells in a TAG. Additionally, or alternatively, although example 400 is described with one TAG per cell, other examples may include multiple TAGs associated with a single cell. For example, a cell may include multiple TRPs, where each TRP is associated with a different TAG.

In order to reduce latency when a UE is moving (and/or when channel conditions are changing), an active serving cell may instruct the UE to switch to a candidate serving cell using an L1 message (e.g., downlink control information (DCI)) or an L2 message (e.g., a MAC control element (MAC-CE)). However, when the candidate serving cell is in a different TAG than the active serving cell, the UE will experience reduced quality and reliability when communicating with the candidate serving cell. As a result, the UE may waste power and processing resources because the candidate serving cell is less likely to receive and decode uplink transmissions from the UE, resulting in more retransmissions.

Some techniques and apparatuses described herein enable a UE (e.g., UE 120) to receive a TA indication, associated with a candidate serving cell configured for L1/L2 mobility, before an L1 message or an L2 message instructing the UE 120 to switch to the candidate serving cell. For example, the UE 120 may apply a TA management procedure (e.g., including TA acquisition and receiving the TA indication) before following an L1/L2 cell switch command when the candidate cell is a deactivated cell. As a result, the UE 120 may perform a timing adjustment before communicating with the candidate serving cell. Therefore, the UE 120 experiences reduced latency because the UE 120 can begin communicating with the candidate serving cell immediately after switching. Additionally, the UE 120 experiences increased reliability and quality of communications, which conserves power and processing resources that would otherwise have been expended on retransmissions.

Alternatively, some techniques and apparatuses described herein enable a UE (e.g., UE 120) to receive a TA indication, associated with a candidate serving cell configured for L1/L2 mobility, with an L1 message or an L2 message instructing the UE 120 to switch to the candidate serving cell. As a result, the UE 120 may perform a timing adjustment during a handover procedure to the candidate serving cell. For example, the UE 120 may trigger a sound reference signal (SRS) transmission to refine a TA for the candidate serving cell when receiving an L1/L2 cell switch command indicating handover to the candidate serving cell. The UE 120 may apply a TA value either indicated in the L1/L2 cell switch command or derived as an initial TA value for the triggered SRS transmission.

Alternatively, some techniques and apparatuses described herein enable a UE (e.g., UE 120) to receive a TA indication, associated with a candidate serving cell configured for L1/L2 mobility, after an L1 message or an L2 message instructing the UE 120 to switch to the candidate serving cell. As a result, the UE 120 may perform a timing adjustment after switching to the candidate serving cell. Because the candidate serving cell provides the TA indication, the active serving cell conserves power and processing resources that would otherwise have been expended on backhaul communications to determine a TA value associated with the candidate serving cell. Additionally, the UE 120 experiences increased reliability and quality of communications, which conserves power and processing resources that would otherwise have been expended on retransmissions.

As indicated above, FIG. 4 is provided as an example. Other examples may differ from what is described with respect to FIG. 4.

FIG. 5 is a diagram illustrating an example 500 associated with providing TA indications before or with an instruction to switch to a candidate serving cell, in accordance with the present disclosure. As shown in FIG. 5, a network node 110 (e.g., an RU 340 and/or a device controlling the RU 340, such as a DU 330 and/or a CU 310) and a UE 120 may communicate with one another (e.g., on a wireless network, such as wireless network 100 of FIG. 1). Some examples may include a plurality of network nodes 110 (e.g., throughout the wireless network 100). In example 500, the network node(s) 110 may represent an active serving cell associated with the UE 120, where the active serving cell may include at least one TRP, as described in connection with FIG. 4.

In some aspects, as shown by reference number 505, the network node(s) 110 may transmit (e.g., directly or via the RU 340), and the UE 120 may receive, a random access channel (RACH) trigger and/or an SRS trigger. Accordingly, the UE 120 may transmit a RACH preamble or an SRS to the candidate serving cell based on the RACH trigger or the SRS trigger for TA acquisition in the candidate serving cell. For example, the RACH or SRS transmission may be configured on the candidate serving cell when the candidate serving cell is deactivated, and the network node(s) 110 may transmit the RACH trigger and/or the SRS trigger to trigger the RACH or SRS transmission on the candidate serving cell before an L1/L2 cell switch command to the candidate serving cell. In another example, the network node(s) 110 may transmit the RACH trigger and/or the SRS trigger in the L1/L2 cell switch command to trigger PRACH or SRS transmission as part of a handover procedure to the candidate serving cell configured for L1/L2 mobility (e.g., as described in connection with FIG. 4).

As shown by reference number 510, the network node(s) 110 may transmit (e.g., directly or via the RU 340), and the UE 120 may receive, a TA indication associated with the candidate serving cell. For example, the TA indication may be included in a MAC-CE.

The TA indication may include a TA identifier associated with a TAG that includes the candidate serving cell. For example, the TA identifier may be a TAG identity (TAG ID) or another type of identifier associated with the TAG. In one example, the TAG may be associated with a transmission configuration indicator (TCI) state associated with the candidate serving cell. Accordingly, the UE 120 applies a TA value indicated in the TA indication when using the TCI state. In another example, the TAG may be associated with at least one reference signal (e.g., an SRS or another type of reference signal) associated with the candidate serving cell. Accordingly, the UE 120 applies a TA value indicated in the TA indication when transmitting the at least one reference signal. In another example, the TAG associated with the candidate serving cell may be a primary TAG. Accordingly, the UE 120 applies a TA value indicated in the TA indication when communicating with the candidate serving cell.

As shown by reference number 515, the UE 120 may perform a timing adjustment based on the TA indication. For example, the UE 120 may apply a TA value indicated in the TA indication, as described above. Because the UE 120 received the TA indication before switching to the candidate serving cell, the UE 120 performs the timing adjustment before communicating with the candidate serving cell.

As shown by reference number 520, the network node(s) 110 may transmit (e.g., directly or via the RU 340), and the UE 120 may receive, an L1 message or an L2 message instructing the UE 120 to switch to the candidate serving cell. For example, the L2 message may be a MAC-CE, and the L1 message may be DCI.

In some aspects, the network node(s) 110 may transmit a handover command (e.g., after transmitting the RACH trigger or the SRS trigger). The handover command may be included in the L1 message or the L2 message. Therefore, the UE 120 may receive the TA indication before the handover command.

Alternatively, the network node(s) 110 may include the TA indication in the L1 message or the L2 message. In some aspects, the TA indication may thus be included in the handover command. The UE 120 may still perform the timing adjustment before communicating with the candidate serving cell because the TA indication is received in the L1 message or the L2 message.

By using techniques as described in connection with FIG. 5, the UE 120 receives the TA indication, associated with the candidate serving cell configured for L1/L2 mobility, before or with the L1 message or the L2 message instructing the UE 120 to switch to the candidate serving cell. As a result, the UE 120 may perform a timing adjustment before communicating with the candidate serving cell. Therefore, the UE 120 experiences reduced latency because the UE 120 can begin communicating with the candidate serving cell immediately after switching. Additionally, the UE 120 experiences increased reliability and quality of communications, which conserves power and processing resources that would otherwise have been expended on retransmissions.

As indicated above, FIG. 5 is provided as an example. Other examples may differ from what is described with respect to FIG. 5.

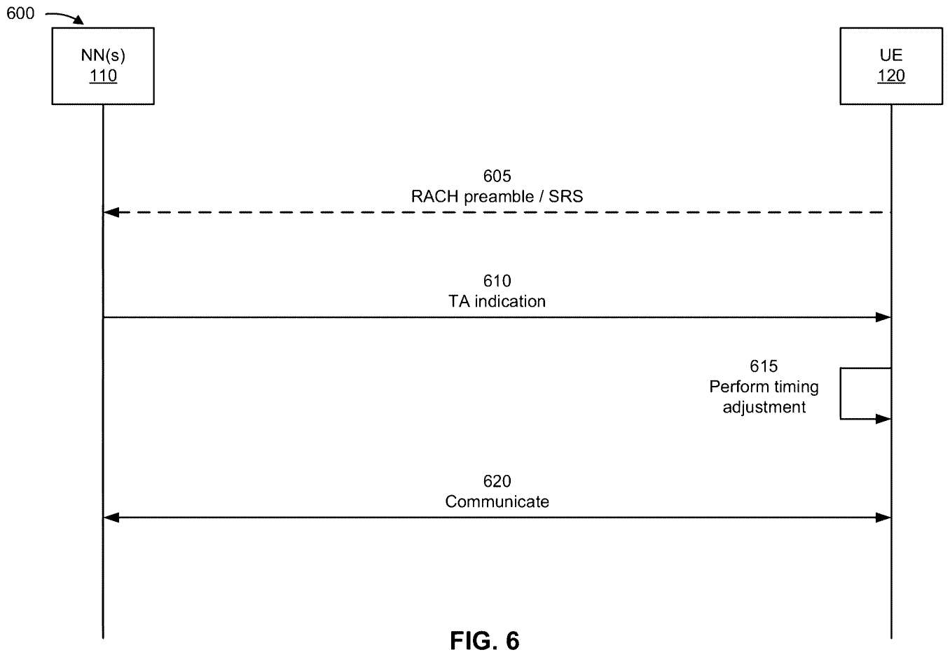

FIG. 6 is a diagram illustrating an example 600 associated with providing TA indications after an instruction to switch to a candidate serving cell, in accordance with the present disclosure. As shown in FIG. 6, a network node 110 (e.g., an RU 340 and/or a device controlling the RU 340, such as a DU 330 and/or a CU 310) and a UE 120 may communicate with one another (e.g., on a wireless network, such as wireless network 100 of FIG. 1). Some examples may include a plurality of network nodes 110 (e.g., throughout the wireless network 100). In example 600, the network node(s) 110 may represent a candidate serving cell associated with the UE 120, where the candidate serving cell may include at least one TRP, as described in connection with FIG. 4.

In some aspects, as shown by reference number 605, the UE 120 may transmit, and the network node(s) 110 may receive (e.g., directly or via the RU 340), a RACH preamble and/or an SRS. For example, an active serving cell may transmit a RACH trigger and/or an SRS trigger to the UE 120 (e.g., as described in connection with reference number 505 of FIG. 5) such that the UE 120 transmits the RACH preamble and/or the SRS based on the RACH trigger and/or the SRS trigger.

The UE 120 may switch to the candidate serving cell. For example, the active serving cell may transmit an L1 message or an L2 message to the UE 120 (e.g., as described in connection with reference number 520 of FIG. 5) such that the UE 120 switches to the candidate serving cell. In some aspects, L1 message or the L2 message may include a handover command.

As shown by reference number 610, the network node(s) 110 may transmit (e.g., directly or via the RU 340), and the UE 120 may receive, a TA indication associated with the candidate serving cell. For example, the TA indication may be included in a MAC-CE. The TA indication may include a TA identifier associated with a TAG that includes the candidate serving cell. For example, the TA identifier may be a TAG ID or another type of identifier associated with the TAG.

As shown by reference number 615, the UE 120 may perform a timing adjustment based on the TA indication. For example, the UE 120 may apply a TA value indicated in the TA indication. Because the UE 120 received the TA indication after switching to the candidate serving cell, the UE 120 performs the timing adjustment after switching. Additionally, the UE 120 may perform the timing adjustment before communicating with the candidate serving cell.

As shown by reference number 620, the UE 120 may communicate with the network node(s) 110 (e.g., directly or via the RU 340). For example, the UE 120 may transmit an uplink transmission to the network node(s) 110 based on the TA indication (e.g., by applying the TA value indicated in the TA indication).

By using techniques as described in connection with FIG. 6, the UE 120 may receive the TA indication after the L1 message or the L2 message instructing the UE 120 to switch to the candidate serving cell. As a result, the UE 120 may perform a timing adjustment after switching to the candidate serving cell. Because the candidate serving cell provides the TA indication, the active serving cell conserves power and processing resources that would otherwise have been expended on backhaul communications to determine a TA value associated with the candidate serving cell. Additionally, the UE 120 experiences increased reliability and quality of communications, which conserves power and processing resources that would otherwise have been expended on retransmissions.

As indicated above, FIG. 6 is provided as an example. Other examples may differ from what is described with respect to FIG. 6.

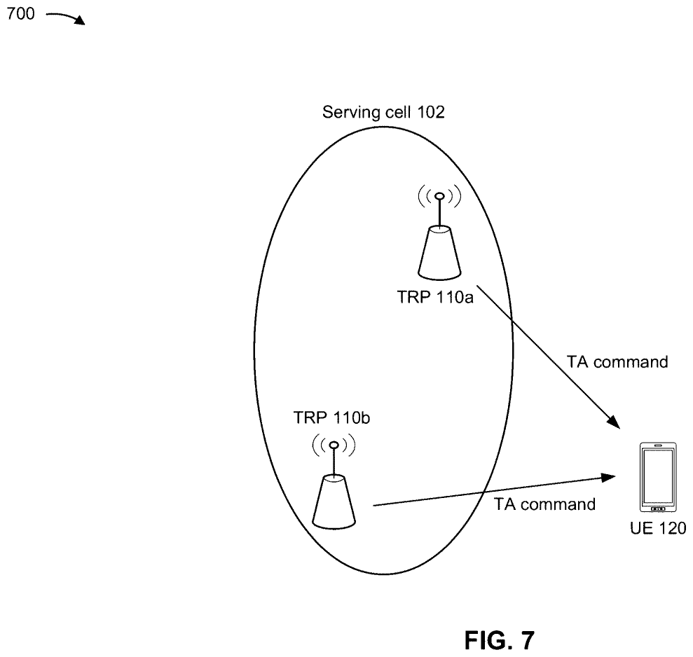

FIG. 7 is a diagram illustrating an example 700 of TAGs for TRPs, in accordance with the present disclosure. In example 700, a UE (e.g., UE 120) may communicate with a serving cell 102. The serving cell 102 may be an active serving cell or a candidate serving cell, as described in connection with FIG. 4. The serving cell 102 includes TRP 110a and TRP 110b. Although example 700 is described with two TRPs, other examples may include additional TRPs in the serving cell 102 (e.g., three TRPs, four TRPs, and so on).

Each TRP of the serving cell 102 may be associated with a TAG. For example, the TRPs 110a and 110b may be sufficiently far apart (e.g., in physical space) such that a difference between a TA value associated with transmissions from the UE 120 to the TRP 110a and a TA value associated with transmissions from the UE 120 to the TRP 110b satisfies a TAG threshold. In example 700, the TRP 110a may be associated with a first TAG, and the TRP 110b may be associated with a second TAG. Accordingly, in example 700, the serving cell 102 may transmit different TA commands for the TRPs 110a and 110b (e.g., corresponding to the different TAGs). Although example 700 is described with each TAG being associated with a single cell (that is, the serving cell 102), other examples may include a TAG that is associated with multiple cells. For example, the first TAG may be associated with TRP 110a as well as one or more TRPs in one or more additional cells, and/or the second TAG may be associated with TRP 110b as well as one or more TRPs in one or more additional cells.

In order to reduce latency when a UE is moving (and/or when channel conditions are changing), an active serving cell may instruct the UE to switch to a candidate serving cell using an L1 message (e.g., downlink control information (DCI)) or an L2 message (e.g., a MAC control element (MAC-CE)). The UE will store TAG configurations (e.g., identifiers of TAGs, such as TAG identities (IDs), in association with timing advance (TA) values corresponding to the TAGs) in order to improve quality and reliability of communications during L1/L2 mobility. However, storing TAG configurations increases memory overhead at the UE. Moreover, consuming additional memory space also results in further power and processing resource consumption at the UE, as well as increased latency in accessing the stored TAG configurations.

Some techniques and apparatuses described herein enable a UE (e.g., UE 120) to receive TAG configurations subject to a maximum quantity of TAGs and/or a maximum quantity of TAGs per candidate serving cell. As a result, the UE 120 conserves memory space that would otherwise have been reserved for TAG configurations beyond the maximum quantity (or maximum quantities). Moreover, conserving memory space also reduces power and processing resource consumption at the UE 120 and decreases latency in accessing stored TAG configurations.

As indicated above, FIG. 7 is provided as an example. Other examples may differ from what is described with respect to FIG. 7.

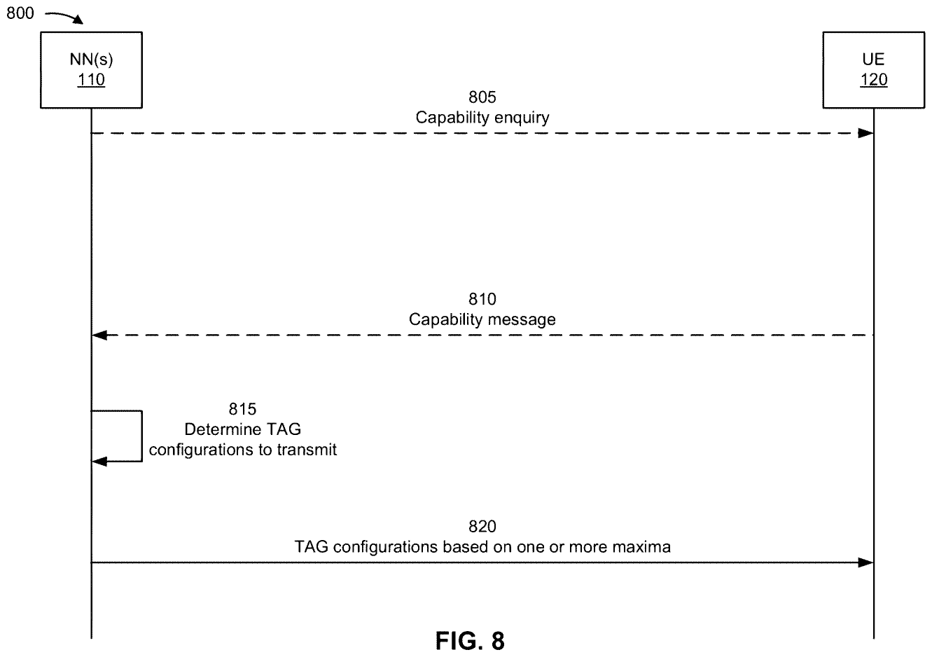

FIG. 8 is a diagram illustrating an example 800 associated with reporting and using maximum quantities of TAGs, in accordance with the present disclosure. As shown in FIG. 8, a network node 110 (e.g., an RU 340 and/or a device controlling the RU 340, such as a DU 330 and/or a CU 310) and a UE 120 may communicate with one another (e.g., on a wireless network, such as wireless network 100 of FIG. 1). Some examples may include a plurality of network nodes 110 (e.g., throughout the wireless network 100). In example 800, the network node(s) 110 may represent an active serving cell associated with the UE 120, as described in connection with FIG. 4, where the active serving cell may include at least one TRP, as described in connection with FIG. 5.

As shown by reference number 805, the network node(s) 110 may transmit (e.g., directly or via the RU 340), and the UE 120 may receive, a capability enquiry. In some aspects, the capability enquiry may be included in an RRC message. The capability enquiry may include a UECapabilityEnquiry data structure (e.g., as defined in 3GPP specifications and/or another standard).

Accordingly, as shown by reference number 810, the UE 120 may transmit, and the network node(s) 110 may receive (e.g., directly or via the RU 340), a capability message in response to the capability enquiry. In some aspects, the capability message may be included in an RRC message. The capability message may include a UECapabilityInformation data structure (e.g., as defined in 3GPP specifications and/or another standard).

The capability message may include an indication of a maximum quantity of TAGs (e.g., represented by X). In some aspects, the maximum quantity of TAGs may apply to all serving cells (e.g., both an active serving cell and any candidate serving cells included in an L1/L2 mobility configuration). Therefore, the UE 120 will receive no more than X TAG configurations in total, where x TAG configurations are associated with the active serving cell and X-x TAG configurations are associated with candidate serving cells. Alternatively, the maximum quantity of TAGs may apply to candidate serving cells (e.g., included in an L1/L2 mobility configuration). Therefore, the UE 120 will receive no more than X TAG configurations for candidate serving cells, where x TAG configurations are associated with the active serving cell and X+x TAG configurations are received in total.

Additionally, or alternatively, the capability message may include an indication of a maximum quantity of TAGs per candidate serving cell (e.g., represented by Y). For example, when Y=1, each candidate serving cell may only be associated with one TAG configuration, regardless of a quantity of TRPs included in the candidate serving cell. In another example, when Y=2, each candidate serving cell may be associated with one TAG configuration or with two TAG configurations (e.g., when multiple TRPs are included in the candidate serving cell).

In some aspects, the maximum quantity of TAGs and/or the maximum quantity of TAGs per candidate serving cell may vary for different band combinations. For example, the UE 120 may indicate a first maximum quantity of TAGs (and/or a first maximum quantity of TAGs per candidate serving cell) associated with a first band combination and may indicate a second maximum quantity of TAGs (and/or a second maximum quantity of TAGs per candidate serving cell) associated with a second band combination. Other examples may include additional maxima associated with additional band combinations.

As shown by reference number 815, the network node(s) 110 may determine how many TAG configurations to transmit to the UE 120 (e.g., directly or via the RU 340). The network node(s) 110 may determine the TAG configurations based on the maximum quantity of TAGs. The network node(s) 110 may determine to transmit TAG configurations corresponding to a list of candidate serving cells until the maximum quantity of TAGs is met. For example, the network node(s) 110 may traverse down the list of candidate serving cells and encode each TAG configuration associated therewith until the maximum quantity of TAGs is met. Additionally, or alternatively, the network node(s) 110 may determine the TAG configurations based on the maximum quantity of TAGs per candidate serving cell. The network node(s) 110 may determine to transmit all TAG configurations corresponding to a candidate serving cell until the maximum quantity of TAGs per candidate serving cell is met. For example, when the maximum quantity of TAGs per candidate serving cell is one, the network node(s) 110 may determine to transmit only a first TAG configuration for each candidate serving cell. In another example, when the maximum quantity of TAGs per candidate serving cell is two, the network node(s) 110 may determine to transmit only a first two TAG configurations for each candidate serving cell that is associated with more than one TAG configuration.

The maximum quantity of TAGs and/or the maximum quantity of TAGs per candidate serving cell may be reported by the UE 120, as described above in connection with reference number 810. Additionally, or alternatively, the maximum quantity of TAGs and/or the maximum quantity of TAGs per candidate serving cell may be stored in a memory of (or otherwise programmed into) the network node(s) 110 (e.g., according to updated 3GPP specifications and/or another standard). Similarly, the maximum quantity of TAGs and/or the maximum quantity of TAGs per candidate serving cell may be stored in a memory of (or otherwise programmed into) the UE 120. In a combinatory example, the UE 120 may indicate which maximum quantity (from a plurality of possible maximum quantities programmed into the network node(s) 110) to use. In another combinatory example, the network node(s) 110 may be programmed with a default maximum that the UE 120 may override with an indication in a capability message.

As shown by reference number 820, the network node(s) 110 may transmit (e.g., directly or via the RU 340), and the UE 120 may receive, TAG configurations.

For example, the network node(s) 110 may transmit at least a first configuration for at least a first TAG including the active serving cell for the UE. In examples where the active serving cell is associated with additional TAGs, the network node(s) 110 may transmit additional configurations for the additional TAGs.

Furthermore, the network node(s) 110 may transmit one or more additional configurations for one or more additional TAGs including one or more candidate serving cells for the UE 120. The network node(s) 110 may transmit the one or more additional configurations based on the maximum quantity of TAGs and/or the maximum quantity of TAGs per candidate serving cell. For example, the network node(s) 110 may determine the one or more additional configurations to transmit, as described above in connection with reference number 815.

In some aspects, the TAGs may be associated with TRPs of the active serving cells and the one or more candidate serving cells. For example, each TAG configuration may include an identifier associated with a corresponding TRP. Alternatively, the TRPs of the active serving cells and the one or more candidate serving cells may be associated with physical cell identities (PCIs). Accordingly, the TAGs may be associated with PCIs of the TRPs. For example, each TAG configuration may include a corresponding PCI.

By using techniques as described in connection with FIG. 8, the UE 120 receives TAG configurations subject to the maximum quantity of TAGs and/or the maximum quantity of TAGs per candidate serving cell. As a result, the UE 120 conserves memory space that would otherwise have been reserved for TAG configurations beyond the maximum quantity (or maximum quantities). Moreover, conserving memory space also reduces power and processing resource consumption at the UE 120 and decreases latency in accessing stored TAG configurations.

As indicated above, FIG. 8 is provided as an example. Other examples may differ from what is described with respect to FIG. 8.

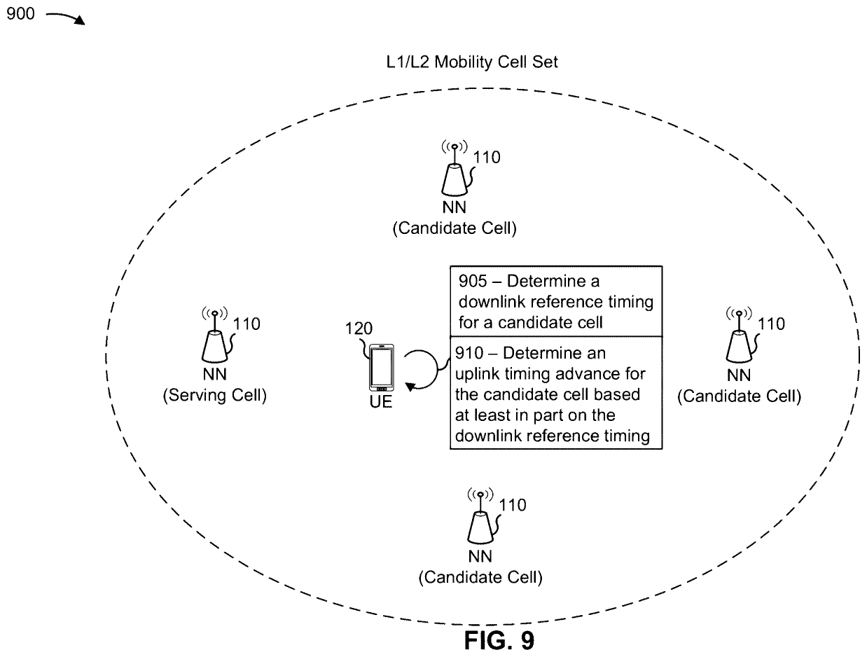

FIG. 9 is a diagram of an example 900 of determining a downlink reference timing for determining an uplink timing advance for a candidate cell, in accordance with the present disclosure. As shown in FIG. 9, the example 900 may include a UE 120. The UE 120 may be included in a wireless network, such as the wireless network 100. The UE 120 may be configured with an L1/L2 mobility cell set for L1/L2 mobility (e.g., L1/L2 based inter-cell mobility). The L1/L2 mobility cell set may include a plurality of cells (e.g., a serving cell and one or more candidate cells). The UE 120 may determine and maintain a list of timing advances (e.g., uplink TAs) for candidate cells in the L1/L2 mobility cell set for L1/L2 mobility latency reduction.

An uplink timing advance refers to a time duration based at least in part on which a UE 120 “advances” uplink transmissions to a network node 110. The UE 120 may advance an uplink transmission (e.g., may start an uplink transmission early) to compensate for propagation delays between the UE 120 and the network node 110. The UE 120 may determine timing advances for candidate cells in the L1/L2 mobility cell set for L1/L2 based mobility, which enables the UE 120 to proactively generate and maintain a list of timing advances for candidate cells prior to handover of the UE 120. In particular, determining and maintaining a list of timing advances for the candidate cells prior to a handover of the UE 120 to a candidate cell enables the UE 120 to more quickly apply a timing advance in the event of a handover or cell switch to a candidate cell. This reduces latency in synchronizing timings between the UE 120 and the candidate cell, reduces the time duration of a random access channel procedure to obtain service from the candidate cell, and/or increases communication efficiency with the candidate cell, among other examples.

At 905 in FIG. 9, the UE 120 may determine a downlink reference timing for a candidate cell. At 910 in FIG. 9, the UE 120 may determine an uplink timing advance for the candidate cell based at least in part on the downlink reference timing. The UE 120 may perform similar operations for other candidate cells in the L1/L2 mobility cell set to maintain a list of uplink timing advances for the candidate cells.

The downlink reference timing may refer to a downlink timing that is used as a reference point in the candidate cell for determination of the uplink timing advance. In some aspects, the UE 120 may determine the downlink reference timing based at least in part on receiving an indication (e.g., from active serving cell of the UE 120) to determine the uplink timing advance for the candidate cell. The indication may include an implicit rule, such as a request for the UE 120 to derive a timing advance of a candidate cell. In some aspects, the UE 120 may determine the downlink reference timing based at least in part on receiving a timing advance command (e.g., from the active serving cell of the UE 120). In some aspects, the UE 120 may determine the downlink reference timing based at least in part on receiving a PRACH indication (e.g., from the active serving cell of the UE 120). The timing advance command may be a PRACH and network node indicated timing advance command. In some aspects, the UE 120 may not start to maintain the downlink reference timing until receiving an indication to determine the uplink timing advance for the candidate cell. The UE 120 may maintain downlink reference timings per timing advance group (TAG) per candidate cell. The UE 120 may be configured with a single TAG per candidate cell as a part of candidate cell configuration. The UE 120 may report to the network with a UE capability of the supportable maximum number of candidate cells that can maintain downlink reference timings. In some aspects, the maximum number of candidate cells that can maintain downlink reference timings may include only a number of candidate cells that requires to maintain downlink reference timings simultaneously. The UE 120 may be indicated a number of candidate cells up to the UE capability to maintain corresponding downlink reference timings.

The UE 120 may determine the downlink reference timing based at least in part on one or more downlink signals associated with the candidate cell, one or more downlink signals associated with an active serving cell of the UE 120, one or more parameters associated with a non-serving cell of the UE 120 (e.g., but still included in the L1/L2 mobility cell set), and/or one or more other downlink signals.

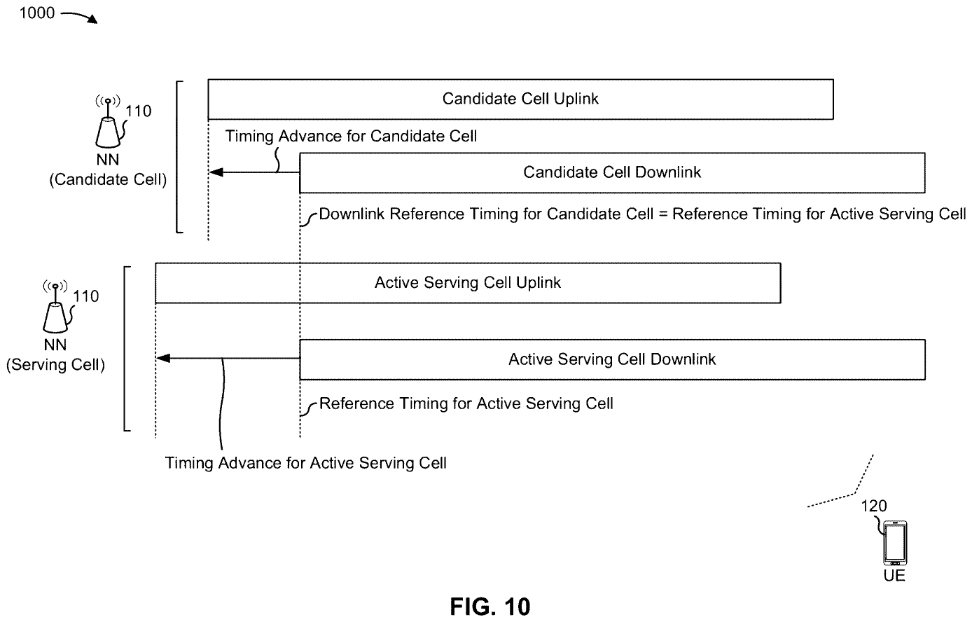

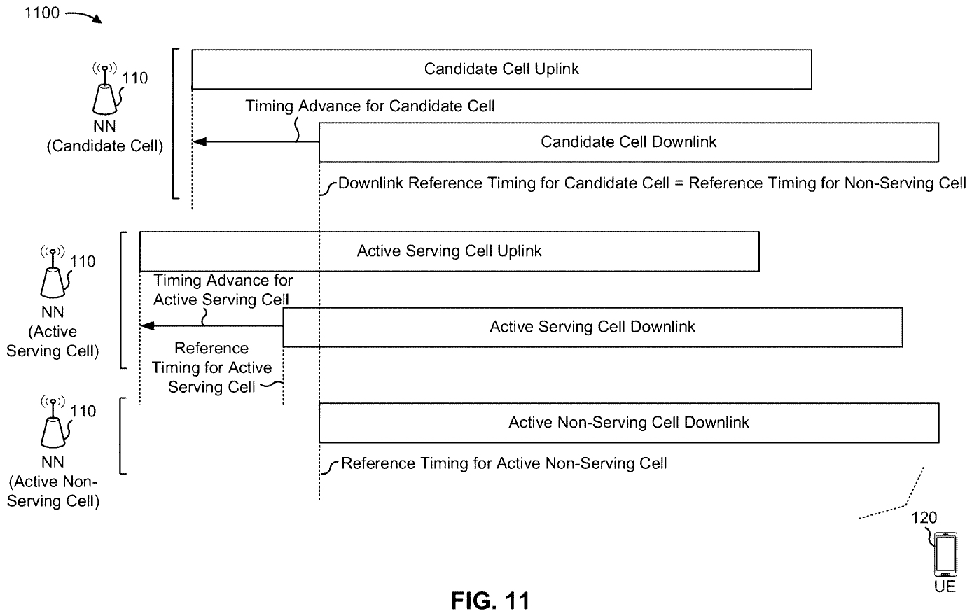

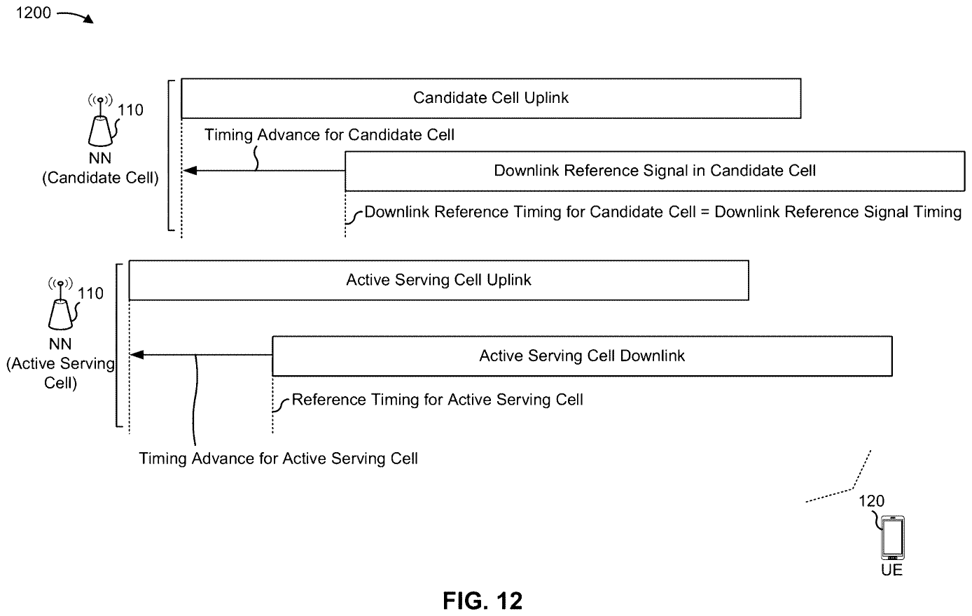

As an example, the UE 120 may determine the downlink reference timing based at least in part on one or more downlink signals associated with the active serving cell of the UE 120, as described in connection with FIG. 10. As another example, the UE 120 may determine the downlink reference timing based at least in part on one or more downlink signals associated with an active non-serving cell of the UE 120, as described in connection with FIG. 11. As another example, the UE 120 may determine the downlink reference timing based at least in part on one or more downlink signals associated with the candidate cell, as described in connection with FIG. 12.

As indicated above, FIG. 9 is provided as an example. Other examples may differ from what is described with regard to FIG. 9.

FIG. 10 is a diagram of an example 1000 of determining a downlink reference timing for determining an uplink timing advance for a candidate cell, in accordance with the present disclosure. In the example 1000, a UE 120 may determine the downlink reference timing based at least in part on one or more downlink signals associated with an active serving cell of the UE 120.

As shown in FIG. 10, the candidate cell may include an uplink and a downlink. Similarly, the active serving cell may also include an uplink and a downlink. The UE 120 may determine a timing advance (e.g., an uplink timing advance) for the active serving cell based at least in part on a reference timing for the active serving cell (e.g., a Reference Timing0).

As further shown in FIG. 10, the UE 120 may determine a timing advance (e.g., an uplink timing advance) for the candidate cell. The UE 120 may determine the timing advance for the candidate cell based at least in part on a downlink reference timing for the candidate cell. As indicated above, the UE 120 may determine the downlink reference timing for the candidate cell based at least in part on one or more downlink signals associated with the active serving cell. In particular, the UE 120 may use the downlink reference timing for the active serving cell (e.g., the Reference Timing0) as the downlink reference timing for the candidate cell (e.g., a Reference Timing1).

The UE 120 may determine the downlink reference timing for the candidate cell based at least in part on a downlink reference timing that is associated with one or more active TCIs of the active serving cell. The UE 120 may use the downlink reference timing, associated with an active TCI of the active serving cell, that corresponds to an earliest synchronization signal block (SSB) that is associated with a TAG (e.g., a TAG #0) for the active TCI of the active serving cell. The UE 120 may use the downlink reference timing of the active serving cell for the timing advance value of the candidate cell.

As indicated above, FIG. 10 is provided as an example. Other examples may differ from what is described with regard to FIG. 10.

FIG. 11 is a diagram of an example 1100 of determining a downlink reference timing for determining an uplink timing advance for a candidate cell, in accordance with the present disclosure. In the example 1100, a UE 120 may determine the downlink reference timing based at least in part on one or more downlink signals associated with an active cell associated with the UE 120. The active cell may be an active serving cell of the UE 120 or an active non-serving cell included in an L1/L2 mobility cell set configured for the UE 120.

As shown in FIG. 11, the candidate cell may include an uplink and a downlink. Similarly, the active serving cell may also include an uplink and a downlink. The UE 120 may determine a timing advance (e.g., an uplink timing advance) for the active serving cell based at least in part on a reference timing for the active serving cell (e.g., a Reference Timing0A).

As further shown in FIG. 11, the UE 120 may determine a timing advance (e.g., an uplink timing advance) for the candidate cell. The UE 120 may determine the timing advance for the candidate cell based at least in part on a downlink reference timing for the candidate cell. The UE 120 may determine the downlink reference timing for the candidate cell based at least in part on one or more downlink signals associated with the active serving cell, the non-active serving cell, or a combination thereof.

As an example, the UE 120 may use the downlink reference timing for the active serving cell (e.g., the Reference Timing0A) as the downlink reference timing for the candidate cell (e.g., a Reference Timing1). The UE 120 may determine the downlink reference timing for the candidate cell based at least in part on a downlink reference timing that is associated with one or more active TCIs of the active serving cell. The active TCI(s) of the active serving cell may be associated with a TAG of a PCI of the candidate cell. The UE 120 may use the downlink reference timing, associated with an active TCI of the active serving cell, that corresponds to an earliest SSB that is associated with the TAG (e.g., a TAG #1) for the active TCI of the active serving cell.

As another example, the UE 120 may use the downlink reference timing for the active non-serving cell (e.g., the Reference Timing0B) as the downlink reference timing for the candidate cell (e.g., a Reference Timing1). The UE 120 may determine the downlink reference timing for the candidate cell based at least in part on a downlink reference timing, associated with an active TCI of the active non-serving cell, that is associated with a TAG of a PCI of the candidate cell. As an example, the active non-serving cell may have a PCI #5 that is associated with the TAG of the candidate cell (e.g., TAG #1), and the UE 120 may determine the downlink reference timing based at least in part on the earliest SSB that is associated with the TAG of the candidate cell. The PCI of the active non-serving cell may be different from the PCI of the active serving cell.

In some aspects, the UE 120 determines the downlink reference timing based at least in part on active TCI(s) in the active serving cell associated with the TAG of the PCI of the candidate cell. A wireless telecommunications standard may enable support to configure TCIs with SSBs associated with an active serving cell PCI and a non-serving cell PCI. In some aspects, the earliest time of SSBs associated with TAG #1 for the candidate cell with a non-serving cell PCI #5 may be used as the downlink reference timing. One or more active TCIs in the active serving cell can be associated with SSBs with the non-serving cell PCI #5.

As indicated above, FIG. 11 is provided as an example. Other examples may differ from what is described with regard to FIG. 11.

FIG. 12 is a diagram of an example 1200 of determining a downlink reference timing for determining an uplink timing advance for a candidate cell, in accordance with the present disclosure. In the example 1200, a UE 120 may determine the downlink reference timing based at least in part on one or more downlink reference signals associated with the candidate cell. The downlink reference signal(s) may be associated with a TAG of the candidate cell.

The candidate cell may include an uplink and a downlink. The UE 120 may be associated with an active serving cell that may also include an uplink and a downlink. The UE 120 may determine a timing advance (e.g., an uplink timing advance) for the active serving cell based at least in part on a reference timing for the active serving cell (e.g., a Reference Timing0).

As further shown in FIG. 12, the UE 120 may determine a timing advance (e.g., an uplink timing advance) for the candidate cell. The UE 120 may determine the timing advance for the candidate cell based at least in part on a downlink reference signal timing (e.g., a Reference Timing1) for one or more downlink reference signals in the candidate cell.

The downlink reference signal(s) may include an SSB associated with the candidate cell, a channel state information reference signal (CSI-RS) associated with the candidate cell, a downlink reference signal that is actively measured for L1 measurement and/or for layer 3 (L3) measurement for the candidate cell, and/or another type of downlink reference signal. In some aspects, the downlink reference signal(s) are configured in the candidate cell (e.g., by the network node 110 of the candidate cell). In some aspects, the downlink reference signal(s) are configured in the active serving cell (e.g., by the network node 110 of the active serving cell).

As indicated above, FIG. 12 is provided as an example. Other examples may differ from what is described with regard to FIG. 12.

FIG. 13 is a diagram illustrating an example process 1300 performed, for example, by a UE, in accordance with the present disclosure. Example process 1300 is an example where the UE (e.g., UE 120 and/or apparatus 2200 of FIG. 22) performs operations associated with TA indications for candidate serving cells.

As shown in FIG. 13, in some aspects, process 1300 may include receiving a TA indication associated with a candidate serving cell configured for L1/L2 mobility (block 1310). For example, the UE (e.g., using communication manager 140 and/or reception component 2202, depicted in FIG. 22) may receive a TA indication associated with a candidate serving cell configured for L1/L2 mobility, as described herein.

As further shown in FIG. 13, in some aspects, process 1300 may include receiving, with the TA indication, an L1 message or an L2 message instructing a switch to the candidate serving cell (block 1320). For example, the UE (e.g., using communication manager 140 and/or reception component 2202) may receive, with the TA indication, an L1 message or an L2 message instructing a switch to the candidate serving cell, as described herein.

As further shown in FIG. 13, in some aspects, process 1300 may include communicating with the candidate serving cell based on the L1 message or the L2 message (block 1330). For example, the UE (e.g., using communication manager 140, reception component 2202, and/or transmission component 2204, depicted in FIG. 22) may communicate with the candidate serving cell based on the L1 message or the L2 message, as described herein.

Process 1300 may include additional aspects, such as any single aspect or any combination of aspects described below and/or in connection with one or more other processes described elsewhere herein.

In a first aspect, the TA indication comprises a MAC-CE.

In a second aspect, alone or in combination with the first aspect, the L2 message comprises a MAC-CE.

In a third aspect, alone or in combination with one or more of the first and second aspects, the L1 message comprises DCI.

In a fourth aspect, alone or in combination with one or more of the first through third aspects, process 1300 includes receiving (e.g., using communication manager 140 and/or reception component 2202) a RACH trigger or an SRS trigger, transmitting (e.g., using communication manager 140 and/or transmission component 2204) a RACH preamble or an SRS to the candidate serving cell based on the RACH trigger or the SRS trigger, and receiving (e.g., using communication manager 140 and/or reception component 2202) a handover command after transmitting the RACH preamble or the SRS.

In a fifth aspect, alone or in combination with one or more of the first through fourth aspects, the TA indication is received before the handover command.

In a sixth aspect, alone or in combination with one or more of the first through fifth aspects, the TA indication is included in the handover command.

In a seventh aspect, alone or in combination with one or more of the first through sixth aspects, the TA indication includes a TA identifier associated with a TAG that includes the candidate serving cell.

In an eighth aspect, alone or in combination with one or more of the first through seventh aspects, the TAG is associated with a TCI state associated with the candidate serving cell.

In a ninth aspect, alone or in combination with one or more of the first through eighth aspects, the TAG is associated with at least one reference signal associated with the candidate serving cell.

In a tenth aspect, alone or in combination with one or more of the first through ninth aspects, the TAG is a primary TAG associated with the candidate serving cell.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network node, in accordance with the present disclosure. Example process 1400 is an example where the network node (e.g., network node 110 and/or apparatus 2300 of FIG. 23) performs operations associated with TA indications for candidate serving cells.

As shown in FIG. 14, in some aspects, process 1400 may include transmitting a TA indication associated with a candidate serving cell configured for L1/L2 mobility (block 1410). For example, the network node (e.g., using communication manager 150 and/or transmission component 2304, depicted in FIG. 23) may transmit a TA indication associated with a candidate serving cell configured for L1/L2 mobility, as described herein.

As further shown in FIG. 14, in some aspects, process 1400 may include transmitting, with the TA indication, an L1 message or an L2 message instructing a switch to the candidate serving cell (block 1420). For example, the network node (e.g., using communication manager 150 and/or transmission component 2304) may transmit, with the TA indication, an L1 message or an L2 message instructing a switch to the candidate serving cell, as described herein.

Process 1400 may include additional aspects, such as any single aspect or any combination of aspects described below and/or in connection with one or more other processes described elsewhere herein.

In a first aspect, the TA indication comprises a MAC-CE.

In a second aspect, alone or in combination with the first aspect, the L2 message comprises a MAC-CE.

In a third aspect, alone or in combination with one or more of the first and second aspects, the L1 message comprises DCI.

In a fourth aspect, alone or in combination with one or more of the first through third aspects, process 1400 includes transmitting (e.g., using communication manager 150 and/or transmission component 2304) a RACH trigger or an SRS trigger, and transmitting (e.g., using communication manager 150 and/or transmission component 2304) a handover command after transmitting the RACH trigger or the SRS trigger.

In a fifth aspect, alone or in combination with one or more of the first through fourth aspects, the TA indication is received before the handover command.

In a sixth aspect, alone or in combination with one or more of the first through fifth aspects, the TA indication is included in the handover command.

In a seventh aspect, alone or in combination with one or more of the first through sixth aspects, the TA indication includes a TA identifier associated with a TAG that includes the candidate serving cell.

In an eighth aspect, alone or in combination with one or more of the first through seventh aspects, the TAG is associated with a TCI state associated with the candidate serving cell.

In a ninth aspect, alone or in combination with one or more of the first through eighth aspects, the TAG is associated with at least one reference signal associated with the candidate serving cell.

In a tenth aspect, alone or in combination with one or more of the first through ninth aspects, the TAG is a primary TAG associated with the candidate serving cell.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a UE, in accordance with the present disclosure. Example process 1500 is an example where the UE (e.g., UE 120 and/or apparatus 2200 of FIG. 22) performs operations associated with TA indications for candidate serving cells.

As shown in FIG. 15, in some aspects, process 1500 may include receiving an L1 message or an L2 message instructing a switch to a candidate serving cell (block 1510). For example, the UE (e.g., using communication manager 140 and/or reception component 2202, depicted in FIG. 22) may receive an L1 message or an L2 message instructing a switch to a candidate serving cell, as described herein.

As further shown in FIG. 15, in some aspects, process 1500 may include receiving, after the L1 message or the L2 message, a TA indication associated with the candidate serving cell (block 1520). For example, the UE (e.g., using communication manager 140 and/or reception component 2202) may receive, after the L1 message or the L2 message, a TA indication associated with the candidate serving cell, as described herein.

As further shown in FIG. 15, in some aspects, process 1500 may include communicating with the candidate serving cell based on the TA indication (block 1530). For example, the UE (e.g., using communication manager 140, reception component 2202, and/or transmission component 2204, depicted in FIG. 22) may communicate with the candidate serving cell based on the TA indication, as described herein.

Process 1500 may include additional aspects, such as any single aspect or any combination of aspects described below and/or in connection with one or more other processes described elsewhere herein.

In a first aspect, the TA indication comprises a MAC-CE.

In a second aspect, alone or in combination with the first aspect, the L2 message comprises a MAC-CE.

In a third aspect, alone or in combination with one or more of the first and second aspects, the L1 message comprises DCI.

In a fourth aspect, alone or in combination with one or more of the first through third aspects, the TA indication includes a TA identifier associated with a TAG that includes the candidate serving cell.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a network node, in accordance with the present disclosure. Example process 1600 is an example where the network node (e.g., network node 110 and/or apparatus 2300 of FIG. 23) performs operations associated with TA indications for candidate serving cells.

As shown in FIG. 16, in some aspects, process 1600 may include transmitting a TA indication associated with a candidate serving cell configured for L1/L2 mobility after an L1 message or an L2 message instructing a switch to the candidate serving cell (block 1610). For example, the network node (e.g., using communication manager 150 and/or transmission component 2304, depicted in FIG. 23) may transmit a TA indication associated with a candidate serving cell configured for L1/L2 mobility after an L1 message or an L2 message instructing a switch to the candidate serving cell, as described herein.

As further shown in FIG. 16, in some aspects, process 1600 may include communicating with a UE based on the TA indication (block 1620). For example, the network node (e.g., using communication manager 150, reception component 2302, and/or transmission component 2304, depicted in FIG. 23) may communicate with a UE based on the TA indication, as described herein.

Process 1600 may include additional aspects, such as any single aspect or any combination of aspects described below and/or in connection with one or more other processes described elsewhere herein.

In a first aspect, the TA indication comprises a MAC-CE.

In a second aspect, alone or in combination with the first aspect, the L2 message comprises a MAC-CE.

In a third aspect, alone or in combination with one or more of the first and second aspects, the L1 message comprises DCI.

In a fourth aspect, alone or in combination with one or more of the first through third aspects, the TA indication includes a TA identifier associated with a TAG that includes the candidate serving cell.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a UE, in accordance with the present disclosure. Example process 1700 is an example where the UE (e.g., UE 120 and/or apparatus 2200 of FIG. 22) performs operations associated with using maximum quantities of TAGs.

As shown in FIG. 17, in some aspects, process 1700 may include receiving at least a first configuration for at least a first TAG including an active serving cell (block 1710). For example, the UE (e.g., using communication manager 140 and/or reception component 2202, depicted in FIG. 22) may receive at least a first configuration for at least a first TAG including an active serving cell, as described herein.

As further shown in FIG. 17, in some aspects, process 1700 may include receiving one or more additional configurations for one or more additional TAGs, including one or more candidate serving cells, based on a maximum quantity of TAGs (block 1720). For example, the UE (e.g., using communication manager 140 and/or reception component 2202) may receive one or more additional configurations for one or more additional TAGs, including one or more candidate serving cells, based on a maximum quantity of TAGs, as described herein.

Process 1700 may include additional aspects, such as any single aspect or any combination of aspects described below and/or in connection with one or more other processes described elsewhere herein.

In a first aspect, the first TAG is associated with a first TRP of the active serving cell, and the one or more additional TAGs are associated with one or more additional TRPs of the one or more candidate serving cells.

In a second aspect, alone or in combination with the first aspect, the first TAG is associated with a first PCI of the active serving cell, and the one or more additional TAGs are associated with one or more additional PCIs of the one or more candidate serving cells.

In a third aspect, alone or in combination with one or more of the first and second aspects, process 1700 includes transmitting (e.g., using communication manager 140 and/or transmission component 2204, depicted in FIG. 22) an indication of the maximum quantity of TAGs, where the maximum quantity of TAGs applies to the one or more additional TAGs.

In a fourth aspect, alone or in combination with one or more of the first through third aspects, the maximum quantity of TAGs is associated with a first band combination, and an additional maximum quantity of TAGs is associated with an additional band combination.

In a fifth aspect, alone or in combination with one or more of the first through fourth aspects, process 1700 includes transmitting (e.g., using communication manager 140 and/or transmission component 2204) an indication of the maximum quantity of TAGs, where the maximum quantity of TAGs applies to the first TAG and the one or more additional TAGs.

In a sixth aspect, alone or in combination with one or more of the first through fifth aspects, the maximum quantity of TAGs is stored on a memory of the UE.

In a seventh aspect, alone or in combination with one or more of the first through sixth aspects, the one or more additional configurations are further based on a maximum quantity of TAGs per candidate serving cell.

In an eighth aspect, alone or in combination with one or more of the first through seventh aspects, process 1700 includes transmitting (e.g., using communication manager 140 and/or transmission component 2204) an indication of the maximum quantity of TAGs per candidate serving cell.

In a ninth aspect, alone or in combination with one or more of the first through eighth aspects, the maximum quantity of TAGs per candidate serving cell is stored on a memory of the UE.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, by a network node, in accordance with the present disclosure. Example process 1800 is an example where the network node (e.g., network node 110 and/or apparatus 2300 of FIG. 23) performs operations associated with using maximum quantities of TAGs.

As shown in FIG. 18, in some aspects, process 1800 may include transmitting at least a first configuration for at least a first TAG including an active serving cell (block 1810). For example, the network node (e.g., using communication manager 150 and/or transmission component 2304, depicted in FIG. 23) may transmit at least a first configuration for at least a first TAG including an active serving cell, as described herein.

As further shown in FIG. 18, in some aspects, process 1800 may include transmitting one or more additional configurations for one or more additional TAGs, including one or more candidate serving cells, based on a maximum quantity of TAGs (block 1820). For example, the network node (e.g., using communication manager 150 and/or transmission component 2304) may transmit one or more additional configurations for one or more additional TAGs, including one or more candidate serving cells, based on a maximum quantity of TAGs, as described herein.

Process 1800 may include additional aspects, such as any single aspect or any combination of aspects described below and/or in connection with one or more other processes described elsewhere herein.

In a first aspect, the first TAG is associated with a first TRP of the active serving cell, and the one or more additional TAGs are associated with one or more additional TRPs of the one or more candidate serving cells.

In a second aspect, alone or in combination with the first aspect, the first TAG is associated with a first PCI of the active serving cell, and the one or more additional TAGs are associated with one or more additional PCIs of the one or more candidate serving cells.

In a third aspect, alone or in combination with one or more of the first and second aspects, process 1800 includes receiving (e.g., using communication manager 150 and/or reception component 2302, depicted in FIG. 23) an indication of the maximum quantity of TAGs, where the maximum quantity of TAGs applies to the one or more additional TAGs.

In a fourth aspect, alone or in combination with one or more of the first through third aspects, the maximum quantity of TAGs is associated with a first band combination, and an additional maximum quantity of TAGs is associated with an additional band combination.

In a fifth aspect, alone or in combination with one or more of the first through fourth aspects, process 1800 includes receiving (e.g., using communication manager 150 and/or reception component 2302) an indication of the maximum quantity of TAGs, where the maximum quantity of TAGs applies to the first TAG and the one or more additional TAGs.

In a sixth aspect, alone or in combination with one or more of the first through fifth aspects, the maximum quantity of TAGs is stored on a memory of the network node.

In a seventh aspect, alone or in combination with one or more of the first through sixth aspects, the one or more additional configurations are further based on a maximum quantity of TAGs per candidate serving cell.

In an eighth aspect, alone or in combination with one or more of the first through seventh aspects, process 1800 includes receiving (e.g., using communication manager 150 and/or reception component 2302) an indication of the maximum quantity of TAGs per candidate serving cell.

In a ninth aspect, alone or in combination with one or more of the first through eighth aspects, the maximum quantity of TAGs per candidate serving cell is stored on a memory of the network node.

Although FIG. 8 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram illustrating an example process 1900 performed, for example, by a UE, in accordance with the present disclosure. Example process 1900 is an example where the UE (e.g., UE 120 and/or apparatus 2200 of FIG. 22) performs operations associated with using maximum quantities of TAGs.

As shown in FIG. 19, in some aspects, process 1900 may include receiving at least a first configuration for at least a first TAG including an active serving cell (block 1910). For example, the UE (e.g., using communication manager 140 and/or reception component 2202, depicted in FIG. 22) may receive at least a first configuration for at least a first TAG including an active serving cell, as described herein.

As further shown in FIG. 19, in some aspects, process 1900 may include receiving one or more additional configurations for one or more additional TAGs, including a candidate serving cell, based on a maximum quantity of TAGs per candidate serving cell (block 1920). For example, the UE (e.g., using communication manager 140 and/or reception component 2202) may receive one or more additional configurations for one or more additional TAGs, including a candidate serving cell, based on a maximum quantity of TAGs per candidate serving cell, as described herein.

Process 1900 may include additional aspects, such as any single aspect or any combination of aspects described below and/or in connection with one or more other processes described elsewhere herein.

In a first aspect, the first TAG is associated with a first TRP of the active serving cell, and the one or more additional TAGs are associated with one or more additional TRPs of the candidate serving cell.

In a second aspect, alone or in combination with the first aspect, the first TAG is associated with a first PCI of the active serving cell, and the one or more additional TAGs are associated with one or more additional PCIs of the candidate serving cell.

In a third aspect, alone or in combination with one or more of the first and second aspects, process 1900 includes transmitting (e.g., using communication manager 140 and/or transmission component 2204, depicted in FIG. 22) an indication of the maximum quantity of TAGs per candidate serving cell.

In a fourth aspect, alone or in combination with one or more of the first through third aspects, the maximum quantity of TAGs per candidate serving cell is stored on a memory of the UE.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a diagram illustrating an example process 2000 performed, for example, by a network node, in accordance with the present disclosure. Example process 2000 is an example where the network node (e.g., network node 110 and/or apparatus 2300 of FIG. 23) performs operations associated with using maximum quantities of TAGs.

As shown in FIG. 20, in some aspects, process 2000 may include transmitting at least a first configuration for at least a first TAG including an active serving cell (block 2010). For example, the network node (e.g., using communication manager 150 and/or transmission component 2304, depicted in FIG. 23) may transmit at least a first configuration for at least a first TAG including an active serving cell, as described herein.

As further shown in FIG. 20, in some aspects, process 2000 may include transmitting one or more additional configurations for one or more additional TAGs, including a candidate serving cell, based on a maximum quantity of TAGs per candidate serving cell (block 2020). For example, the network node (e.g., using communication manager 150 and/or transmission component 2304) may transmit one or more additional configurations for one or more additional TAGs, including a candidate serving cell, based on a maximum quantity of TAGs per candidate serving cell, as described herein.

Process 2000 may include additional aspects, such as any single aspect or any combination of aspects described below and/or in connection with one or more other processes described elsewhere herein.

In a first aspect, the first TAG is associated with a first TRP of the active serving cell, and the one or more additional TAGs are associated with one or more additional TRPs of the candidate serving cell.

In a second aspect, alone or in combination with the first aspect, the first TAG is associated with a first PCI of the active serving cell, and the one or more additional TAGs are associated with one or more additional PCIs of the candidate serving cell.

In a third aspect, alone or in combination with one or more of the first and second aspects, process 2000 includes receiving (e.g., using communication manager 150 and/or reception component 2302, depicted in FIG. 23) an indication of the maximum quantity of TAGs per candidate serving cell.

In a fourth aspect, alone or in combination with one or more of the first through third aspects, the maximum quantity of TAGs per candidate serving cell is stored on a memory of the network node.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

FIG. 21 is a diagram illustrating an example process 2100 performed, for example, by a UE, in accordance with the present disclosure. Example process 2100 is an example where the UE (e.g., UE 120 and/or apparatus 2200 of FIG. 22) performs operations associated with determining a downlink reference timing for determining a timing advance for a candidate cell.

As shown in FIG. 21, in some aspects, process 2100 may include determining a downlink reference timing for a candidate cell (block 2110). For example, the UE (e.g., using communication manager 140 and/or determination component 2212, depicted in FIG. 22) may determine a downlink reference timing for a candidate cell, as described herein.

As further shown in FIG. 21, in some aspects, process 2100 may include determining, based at least in part on the downlink reference timing, an uplink timing advance for the candidate cell (block 2120). For example, the UE (e.g., using communication manager 140 and/or determination component 2212) may determine, based at least in part on the downlink reference timing, an uplink timing advance for the candidate cell, as described herein. In some aspects, the uplink timing advance is for L1/L2 based mobility.

Process 2100 may include additional aspects, such as any single aspect or any combination of aspects described below and/or in connection with one or more other processes described elsewhere herein.

In a first aspect, determining the downlink reference timing includes determining the downlink reference timing for the candidate cell based at least in part on a downlink reference timing that is associated with an active TCI of an active serving cell associated with the UE.

In a second aspect, alone or in combination with the first aspect, the downlink reference timing that is associated with the active TCI of the active serving cell associated with the UE corresponds to an earliest SSB that is associated with a TAG for the active TCI of the active serving cell.

In a third aspect, alone or in combination with one or more of the first and second aspects, determining the downlink reference timing includes determining the downlink reference timing for the candidate cell based at least in part on a downlink reference timing that is associated with an active TCI of an active cell, associated with the UE, that is associated with a TAG of a PCI of the candidate cell.

In a fourth aspect, alone or in combination with one or more of the first through third aspects, the active cell is a serving cell of the UE.

In a fifth aspect, alone or in combination with one or more of the first through fourth aspects, the active cell is a non-serving cell of the UE, and a PCI of the active cell is different from a PCI of a serving cell of the UE.

In a sixth aspect, alone or in combination with one or more of the first through fifth aspects, the downlink reference timing that is associated with the active TCI of the active cell associated with the UE corresponds to an earliest SSB that is associated with a TAG for the active TCI of the active cell.

In a seventh aspect, alone or in combination with one or more of the first through sixth aspects, determining the downlink reference timing includes determining the downlink reference timing for the candidate cell based at least in part on a downlink reference signal that is associated with a TAG of the candidate cell.

In an eighth aspect, alone or in combination with one or more of the first through seventh aspects, the downlink reference signal includes at least one of an SSB associated with the candidate cell, or a CSI-RS that is associated with the candidate cell.

In a ninth aspect, alone or in combination with one or more of the first through eighth aspects, the downlink reference signal is configured in an active serving cell of the UE.

In a tenth aspect, alone or in combination with one or more of the first through ninth aspects, the downlink reference signal is configured in the candidate cell.

In an eleventh aspect, alone or in combination with one or more of the first through tenth aspects, determining the downlink reference timing includes determining the downlink reference timing for the candidate cell based at least in part on receiving an indication to determine the uplink timing advance for the candidate cell.

In a twelfth aspect, alone or in combination with one or more of the first through eleventh aspects, determining the downlink reference timing includes determining the downlink reference timing for the candidate cell based at least in part on receiving a timing advance command.

In a thirteenth aspect, alone or in combination with one or more of the first through twelfth aspects, determining the uplink timing advance for the candidate cell includes determining the uplink timing advance for the candidate cell prior to handover of the UE to the candidate cell.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

FIG. 22 is a diagram of an example apparatus 2200 for wireless communication, in accordance with the present disclosure. The apparatus 2200 may be a UE, or a UE may include the apparatus 2200. In some aspects, the apparatus 2200 includes a reception component 2202 and a transmission component 2204, which may be in communication with one another (for example, via one or more buses and/or one or more other components). As shown, the apparatus 2200 may communicate with another apparatus 2206 (such as a UE, an RU, or another wireless communication device) using the reception component 2202 and the transmission component 2204. As further shown, the apparatus 2200 may include the communication manager 140. The communication manager 140 may include a TA component 2208, a memory controller 2210, and/or a determination component 2212, among other examples.

In some aspects, the apparatus 2200 may be configured to perform one or more operations described herein in connection with FIGS. 5-12. Additionally, or alternatively, the apparatus 2200 may be configured to perform one or more processes described herein, such as process 1300 of FIG. 13, process 1500 of FIG. 15, process 1700 of FIG. 17, process 1900 of FIG. 19, process 2100 of FIG. 21, or a combination thereof. In some aspects, the apparatus 2200 and/or one or more components shown in FIG. 22 may include one or more components of the UE described in connection with FIG. 2. Additionally, or alternatively, one or more components shown in FIG. 22 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2202 may receive communications, such as reference signals, control information, data communications, or a combination thereof, from the apparatus 2206. The reception component 2202 may provide received communications to one or more other components of the apparatus 2200. In some aspects, the reception component 2202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2200. In some aspects, the reception component 2202 may include one or more antennas, a modem, a demodulator, a MIMO detector, a receive processor, a controller/processor, a memory, or a combination thereof, of the UE described in connection with FIG. 2.

The transmission component 2204 may transmit communications, such as reference signals, control information, data communications, or a combination thereof, to the apparatus 2206. In some aspects, one or more other components of the apparatus 2200 may generate communications and may provide the generated communications to the transmission component 2204 for transmission to the apparatus 2206. In some aspects, the transmission component 2204 may perform signal processing on the generated communications (such as filtering, amplification, modulation, digital-to-analog conversion, multiplexing, interleaving, mapping, or encoding, among other examples), and may transmit the processed signals to the apparatus 2206. In some aspects, the transmission component 2204 may include one or more antennas, a modem, a modulator, a transmit MIMO processor, a transmit processor, a controller/processor, a memory, or a combination thereof, of the UE described in connection with FIG. 2. In some aspects, the transmission component 2204 may be co-located with the reception component 2202 in a transceiver.

In some aspects, the reception component 2202 may receive (e.g., from the apparatus 2206) a TA indication associated with a candidate serving cell configured for L1/L2 mobility. The TA component 2208 may thus perform a timing adjustment based on the TA indication. The TA component 2208 may include one or more antennas, a modem, a demodulator, a MIMO detector, a receive processor, a modulator, a transmit MIMO processor, a transmit processor, a controller/processor, a memory, or a combination thereof, of the UE described in connection with FIG. 2. Additionally, the reception component 2202 may receive, after or with the TA indication, an L1 message or an L2 message instructing the apparatus 2200 to switch to the candidate serving cell. Accordingly, the reception component 2202 and/or the transmission component 2204 may communicate with the candidate serving cell based on the L1 message or the L2 message.

In some aspects, the reception component 2202 may receive (e.g., from the apparatus 2206) a RACH trigger or an SRS trigger. Accordingly, the transmission component 2204 may transmit a RACH preamble or an SRS to the candidate serving cell based on the RACH trigger or the SRS trigger. Therefore, the reception component 2202 may receive a handover command after transmitting the RACH preamble or the SRS, and the TA indication may be received before or with the handover command.

Alternatively, the reception component 2202 may receive (e.g., from the apparatus 2206) an L1 message or an L2 message instructing the UE to switch to a candidate serving cell. The reception component 2202 may further receive, after the L1 message or the L2 message, a TA indication associated with the candidate serving cell. Accordingly, the reception component 2202 and/or the transmission component 2204 may communicate with the candidate serving cell based on the TA indication. Additionally, the TA component 2208 may thus perform a timing adjustment based on the TA indication.

In some aspects, the reception component 2202 may receive (e.g., from the apparatus 2206) at least a first configuration for at least a first TAG including an active serving cell for the apparatus 2200. The reception component 2202 may further receive one or more additional configurations for one or more additional TAGs, including one or more candidate serving cells for the apparatus 2200, based on a maximum quantity of TAGs. Additionally, or alternatively, the reception component 2202 may receive one or more additional configurations for one or more additional TAGs, including a candidate serving cell for the apparatus 2200, based on a maximum quantity of TAGs per candidate serving cell. Accordingly, the memory controller 2210 may reserve memory space for TAG configurations based on the maximum quantity of TAGs and/or the maximum quantity of TAGs per candidate serving cell.

In some aspects, the transmission component 2204 may transmit (e.g., to the apparatus 2206) an indication of the maximum quantity of TAGs. Similarly, the transmission component 2204 may transmit an indication of the maximum quantity of TAGs per candidate serving cell.

In some aspects, the determination component 2212 may determine a downlink reference timing for a candidate cell. The determination component 2212 may include a modem, a demodulator, a MIMO detector, a receive processor, a modulator, a transmit MIMO processor, a transmit processor, a controller/processor, a memory, or a combination thereof, of the UE described in connection with FIG. 2. The determination component 2212 may determine, based at least in part on the downlink reference timing, an uplink timing advance for the candidate cell wherein the uplink timing advance is for L1/L2 based mobility.

The number and arrangement of components shown in FIG. 22 are provided as an example. In practice, there may be additional components, fewer components, different components, or differently arranged components than those shown in FIG. 22. Furthermore, two or more components shown in FIG. 22 may be implemented within a single component, or a single component shown in FIG. 22 may be implemented as multiple, distributed components. Additionally, or alternatively, a set of (one or more) components shown in FIG. 22 may perform one or more functions described as being performed by another set of components shown in FIG. 22.

FIG. 23 is a diagram of an example apparatus 2300 for wireless communication, in accordance with the present disclosure. The apparatus 2300 may be a network node, or a network node may include the apparatus 2300. In some aspects, the apparatus 2300 includes a reception component 2302 and a transmission component 2304, which may be in communication with one another (for example, via one or more buses and/or one or more other components). As shown, the apparatus 2300 may communicate with another apparatus 2306 (such as a UE, an RU, or another wireless communication device) using the reception component 2302 and the transmission component 2304. As further shown, the apparatus 2300 may include the communication manager 150. The communication manager 150 may include a handover component 2308 and/or a capability component 2310, among other examples.

In some aspects, the apparatus 2300 may be configured to perform one or more operations described herein in connection with FIGS. 5-12. Additionally, or alternatively, the apparatus 2300 may be configured to perform one or more processes described herein, such as process 1400 of FIG. 14, process 1600 of FIG. 16, process 1800 of FIG. 18, process 2000 of FIG. 20, or a combination thereof. In some aspects, the apparatus 2300 and/or one or more components shown in FIG. 23 may include one or more components of the network node described in connection with FIG. 2. Additionally, or alternatively, one or more components shown in FIG. 23 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2302 may receive communications, such as reference signals, control information, data communications, or a combination thereof, from the apparatus 2306. The reception component 2302 may provide received communications to one or more other components of the apparatus 2300. In some aspects, the reception component 2302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2300. In some aspects, the reception component 2302 may include one or more antennas, a modem, a demodulator, a MIMO detector, a receive processor, a controller/processor, a memory, or a combination thereof, of the network node described in connection with FIG. 2.

The transmission component 2304 may transmit communications, such as reference signals, control information, data communications, or a combination thereof, to the apparatus 2306. In some aspects, one or more other components of the apparatus 2300 may generate communications and may provide the generated communications to the transmission component 2304 for transmission to the apparatus 2306. In some aspects, the transmission component 2304 may perform signal processing on the generated communications (such as filtering, amplification, modulation, digital-to-analog conversion, multiplexing, interleaving, mapping, or encoding, among other examples), and may transmit the processed signals to the apparatus 2306. In some aspects, the transmission component 2304 may include one or more antennas, a modem, a modulator, a transmit MIMO processor, a transmit processor, a controller/processor, a memory, or a combination thereof, of the network node described in connection with FIG. 2. In some aspects, the transmission component 2304 may be co-located with the reception component 2302 in a transceiver.

In some aspects, the transmission component 2304 may transmit a TA indication associated with a candidate serving cell configured for L1/L2 mobility. Additionally, the transmission component 2304 may transmit, after or with the TA indication, an L1 message or an L2 message instructing a UE (e.g., the apparatus 2306) to switch to the candidate serving cell.

The apparatus 2300 may be associated with an active serving cell. Accordingly, the handover component 2308 may perform handover for the UE to the candidate serving cell. For example, the transmission component 2304 may transmit a RACH trigger or an SRS trigger. Additionally, the transmission component 2304 may transmit a handover command after transmitting the RACH trigger or the SRS trigger.

Alternatively, the transmission component 2304 may transmit a TA indication associated with a candidate serving cell configured for L1/L2 mobility after an L1 message or an L2 message instructing a UE (e.g., the apparatus 2306) to switch to the candidate serving cell. Accordingly, the reception component 2302 and/or the transmission component 2304 may communicate with the UE based on the TA indication.

In some aspects, the transmission component 2304 may transmit (e.g., to the apparatus 2306) at least a first configuration for at least a first TAG including an active serving cell for a UE (e.g., the apparatus 2306). The transmission component 2304 may further transmit one or more additional configurations for one or more additional TAGs, including one or more candidate serving cells for the UE, based on a maximum quantity of TAGs. Additionally, or alternatively, the transmission component 2304 may transmit one or more additional configurations for one or more additional TAGs, including a candidate serving cell for the UE, based on a maximum quantity of TAGs per candidate serving cell.

In some aspects, the reception component 2302 may receive (e.g., from the apparatus 2306) an indication of the maximum quantity of TAGs. For example, the capability component 2310 may encode a capability enquiry, and the reception component 2302 may transmit the capability enquiry (e.g., to the apparatus 2306). Accordingly, the reception component 2302 may receive the indication of the maximum quantity of TAGs in a capability message in response to the capability enquiry. Similarly, the reception component 2302 may receive an indication of the maximum quantity of TAGs per candidate serving cell.

The number and arrangement of components shown in FIG. 23 are provided as an example. In practice, there may be additional components, fewer components, different components, or differently arranged components than those shown in FIG. 23. Furthermore, two or more components shown in FIG. 23 may be implemented within a single component, or a single component shown in FIG. 23 may be implemented as multiple, distributed components. Additionally, or alternatively, a set of (one or more) components shown in FIG. 23 may perform one or more functions described as being performed by another set of components shown in FIG. 23.

The following provides an overview of some Aspects of the present disclosure:
Aspect 1: A method of wireless communication performed by a user equipment (UE), comprising: receiving a timing advance (TA) indication associated with a candidate serving cell configured for layer 1/Layer 2 (L1/L2) mobility; receiving, after or with the TA indication, an L1 message or an L2 message instructing the UE to switch to the candidate serving cell; and communicating with the candidate serving cell based on the L1 message or the L2 message.
Aspect 2: The method of Aspect 1, wherein the TA indication comprises a medium access control layer control element.
Aspect 3: The method of any of Aspects 1-2, wherein the L2 message comprises a medium access control layer control element.
Aspect 4: The method of any of Aspects 1-3, wherein the L1 message comprises downlink control information.
Aspect 5: The method of any of Aspects 1-4, further comprising: receiving a random access channel (RACH) trigger or a sounding reference signal (SRS) trigger; transmitting a RACH preamble or an SRS to the candidate serving cell based on the RACH trigger or the SRS trigger; and receiving a handover command after transmitting the RACH preamble or the SRS.
Aspect 6: The method of Aspect 5, wherein the TA indication is received before the handover command.
Aspect 7: The method of Aspect 5, wherein the TA indication is included in the handover command.
Aspect 8: The method of any of Aspects 1-7, wherein the TA indication includes a TA identifier associated with a TA group (TAG) that includes the candidate serving cell.
Aspect 9: The method of Aspect 8, wherein the TAG is associated with a transmission configuration indicator state associated with the candidate serving cell.
Aspect 10: The method of Aspect 8, wherein the TAG is associated with at least one reference signal associated with the candidate serving cell.
Aspect 11: The method of Aspect 8, wherein the TAG is a primary TAG associated with the candidate serving cell.
Aspect 12: A method of wireless communication performed by a network node, comprising: transmitting a timing advance (TA) indication associated with a candidate serving cell configured for layer 1/layer 2 (L1/L2) mobility; and transmitting, after or with the TA indication, an L1 message or an L2 message instructing a user equipment (UE) to switch to the candidate serving cell.
Aspect 13: The method of Aspect 12, wherein the TA indication comprises a medium access control layer control element.
Aspect 14: The method of any of Aspects 12-13, wherein the L2 message comprises a medium access control layer control element.
Aspect 15: The method of any of Aspects 12-14, wherein the L1 message comprises downlink control information.
Aspect 16: The method of any of Aspects 12-15, further comprising: transmitting a random access channel (RACH) trigger or a sounding reference signal (SRS) trigger; and transmitting a handover command after transmitting the RACH trigger or the SRS trigger.
Aspect 17: The method of Aspect 16, wherein the TA indication is received before the handover command.
Aspect 18: The method of Aspect 16, wherein the TA indication is included in the handover command.
Aspect 19: The method of any of Aspects 12-18, wherein the TA indication includes a TA identifier associated with a TA group (TAG) that includes the candidate serving cell.
Aspect 20: The method of Aspect 19, wherein the TAG is associated with a transmission configuration indicator state associated with the candidate serving cell.
Aspect 21: The method of Aspect 19, wherein the TAG is associated with at least one reference signal associated with the candidate serving cell.
Aspect 22: The method of Aspect 19, wherein the TAG is a primary TAG associated with the candidate serving cell.
Aspect 23: A method of wireless communication performed by a user equipment (UE), comprising: receiving a layer 1 (L1) message or a layer 2 (L2) message instructing the UE to switch to a candidate serving cell; receiving, after the L1 message or the L2 message, a timing advance (TA) indication associated with the candidate serving cell; and communicating with the candidate serving cell based on the TA indication.
Aspect 24: The method of Aspect 23, wherein the TA indication comprises a medium access control layer control element.
Aspect 25: The method of any of Aspects 23-24, wherein the L2 message comprises a medium access control layer control element.
Aspect 26: The method of any of Aspects 23-25, wherein the L1 message comprises downlink control information.
Aspect 27: The method of any of Aspects 23-26, wherein the TA indication includes a TA identifier associated with a TA group (TAG) that includes the candidate serving cell.
Aspect 28: A method of wireless communication performed by a network node, comprising: transmitting a timing advance (TA) indication associated with a candidate serving cell configured for layer 1/layer 2 (L1/L2) mobility after an L1 message or an L2 message instructing a user equipment (UE) to switch to the candidate serving cell; and communicating with the UE based on the TA indication.
Aspect 29: The method of Aspect 28, wherein the TA indication comprises a medium access control layer control element.
Aspect 30: The method of any of Aspects 28-29, wherein the L2 message comprises a medium access control layer control element.
Aspect 31: The method of any of Aspects 28-30, wherein the L1 message comprises downlink control information.
Aspect 32: The method of any of Aspects 28-31, wherein the TA indication includes a TA identifier associated with a TA group (TAG) that includes the candidate serving cell.
Aspect 33: A method of wireless communication performed by a user equipment (UE), comprising: receiving at least a first configuration for at least a first timing advance group (TAG) including an active serving cell for the UE; and receiving one or more additional configurations for one or more additional TAGs including one or more candidate serving cells for the UE based on a maximum quantity of TAGs.
Aspect 34: The method of Aspect 33, wherein the first TAG is associated with a first transmit-receive point (TRP) of the active serving cell, and the one or more additional TAGs are associated with one or more additional TRPs of the one or more candidate serving cells.
Aspect 35: The method of any of Aspects 33-34, wherein the first TAG is associated with a first physical cell identity (PCI) of the active serving cell, and the one or more additional TAGs are associated with one or more additional PCIs of the one or more candidate serving cells.
Aspect 36: The method of any of Aspects 33-35, further comprising: transmitting an indication of the maximum quantity of TAGs, wherein the maximum quantity of TAGs applies to the one or more additional TAGs.
Aspect 37: The method of any of Aspects 33-36, wherein the maximum quantity of TAGs is associated with a first band combination, and an additional maximum quantity of TAGs is associated with an additional band combination.
Aspect 38: The method of any of Aspects 33-37, further comprising: transmitting an indication of the maximum quantity of TAGs, wherein the maximum quantity of TAGs applies to the first TAG and the one or more additional TAGs.
Aspect 39: The method of any of Aspects 33-38, wherein the maximum quantity of TAGs is stored on a memory of the UE.
Aspect 40: The method of any of Aspects 33-39, wherein the one or more additional configurations are further based on a maximum quantity of TAGs per candidate serving cell.
Aspect 41: The method of Aspect 40, further comprising: transmitting an indication of the maximum quantity of TAGs per candidate serving cell.
Aspect 42: The method of any of Aspects 40-41, wherein the maximum quantity of TAGs per candidate serving cell is stored on a memory of the UE.
Aspect 43: A method of wireless communication performed by a network node, comprising: transmitting at least a first configuration for at least a first timing advance group (TAG) including an active serving cell for a user equipment (UE); and transmitting one or more additional configurations for one or more additional TAGs including one or more candidate serving cells for the UE based on a maximum quantity of TAGs.
Aspect 44: The method of Aspect 43, wherein the first TAG is associated with a first transmit-receive point (TRP) of the active serving cell, and the one or more additional TAGs are associated with one or more additional TRPs of the one or more candidate serving cells.
Aspect 45: The method of any of Aspects 43-44, wherein the first TAG is associated with a first physical cell identity (PCI) of the active serving cell, and the one or more additional TAGs are associated with one or more additional PCIs of the one or more candidate serving cells.
Aspect 46: The method of any of Aspects 43-45, further comprising: receiving an indication of the maximum quantity of TAGs, wherein the maximum quantity of TAGs applies to the one or more additional TAGs.
Aspect 47: The method of any of Aspects 43-46, wherein the maximum quantity of TAGs is associated with a first band combination, and an additional maximum quantity of TAGs is associated with an additional band combination.
Aspect 48: The method of any of Aspects 43-47, further comprising: receiving an indication of the maximum quantity of TAGs, wherein the maximum quantity of TAGs applies to the first TAG and the one or more additional TAGs.
Aspect 49: The method of any of Aspects 43-48, wherein the maximum quantity of TAGs is stored on a memory of the network node.
Aspect 50: The method of any of Aspects 43-49, wherein the one or more additional configurations are further based on a maximum quantity of TAGs per candidate serving cell.
Aspect 51: The method of Aspect 50, further comprising: receiving an indication of the maximum quantity of TAGs per candidate serving cell.
Aspect 52: The method of any of Aspects 50-51, wherein the maximum quantity of TAGs per candidate serving cell is stored on a memory of the network node.
Aspect 53: A method of wireless communication performed by a user equipment (UE), comprising: receiving at least a first configuration for at least a first timing advance group (TAG) including an active serving cell for the UE; and receiving one or more additional configurations for one or more additional TAGs including a candidate serving cell for the UE based on a maximum quantity of TAGs per candidate serving cell.
Aspect 54: The method of Aspect 53, wherein the first TAG is associated with a first transmit-receive point (TRP) of the active serving cell, and the one or more additional TAGs are associated with one or more additional TRPs of the candidate serving cell.
Aspect 55: The method of any of Aspects 53-54, wherein the first TAG is associated with a first physical cell identity (PCI) of the active serving cell, and the one or more additional TAGs are associated with one or more additional PCIs of the candidate serving cell.
Aspect 56: The method of any of Aspects 53-55, further comprising: transmitting an indication of the maximum quantity of TAGs per candidate serving cell.
Aspect 57: The method of any of Aspects 53-56, wherein the maximum quantity of TAGs per candidate serving cell is stored on a memory of the UE.
Aspect 58: A method of wireless communication performed by a network node, comprising: transmitting at least a first configuration for at least a first timing advance group (TAG) including an active serving cell for a user equipment (UE); and transmitting one or more additional configurations for one or more additional TAGs including a candidate serving cell for the UE based on a maximum quantity of TAGs per candidate serving cell.
Aspect 59: The method of Aspect 58, wherein the first TAG is associated with a first transmit-receive point (TRP) of the active serving cell, and the one or more additional TAGs are associated with one or more additional TRPs of the candidate serving cell.
Aspect 60: The method of any of Aspects 58-59, wherein the first TAG is associated with a first physical cell identity (PCI) of the active serving cell, and the one or more additional TAGs are associated with one or more additional PCIs of the candidate serving cell.
Aspect 61: The method of any of Aspects 58-60, further comprising: receiving an indication of the maximum quantity of TAGs per candidate serving cell.
Aspect 62: The method of any of Aspects 58-61, wherein the maximum quantity of TAGs per candidate serving cell is stored on a memory of the network node.
Aspect 63: A method of wireless communication performed by a user equipment (UE), comprising: determining a downlink reference timing for a candidate cell; and determining, based at least in part on the downlink reference timing, an uplink timing advance for the candidate cell, wherein the uplink timing advance is for layer 1 (L1) or layer (L2) based mobility.
Aspect 64: The method of Aspect 63, wherein determining the downlink reference timing comprises: determining the downlink reference timing for the candidate cell based at least in part on a downlink reference timing that is associated with an active transmission configuration indication (TCI) of an active serving cell associated with the UE.
Aspect 65: The method of Aspect 64, wherein the downlink reference timing that is associated with the active TCI of the active serving cell associated with the UE corresponds to an earliest synchronization signal block (SSB) that is associated with a timing advance group (TAG) for the active TCI of the active serving cell.
Aspect 66: The method of any of Aspects 63-65, wherein determining the downlink reference timing comprises: determining the downlink reference timing for the candidate cell based at least in part on a downlink reference timing that is associated with an active transmission configuration indication (TCI) of an active cell, associated with the UE, that is associated with a timing advance group (TAG) of a physical cell identifier (PCI) of the candidate cell.
Aspect 67: The method of Aspect 66, wherein the active cell is a serving cell of the UE.
Aspect 68: The method of any of Aspects 66-67, wherein the active cell is a non-serving cell of the UE; and wherein a PCI of the active cell is different from a PCI of a serving cell of the UE.
Aspect 69: The method of any of Aspects 66-68, wherein the downlink reference timing that is associated with the active TCI of the active cell associated with the UE corresponds to an earliest synchronization signal block (SSB) that is associated with a timing advance group (TAG) for the active TCI of the active cell.
Aspect 70: The method of any of Aspects 63-69, wherein determining the downlink reference timing comprises: determining the downlink reference timing for the candidate cell based at least in part on a downlink reference signal that is associated with a timing advance group (TAG) of the candidate cell.
Aspect 71: The method of Aspect 70, wherein the downlink reference signal comprises at least one of: a synchronization signal block (SSB) associated with the candidate cell, or a channel state information reference signal (CSI-RS) that is associated with the candidate cell.
Aspect 72: The method of any of Aspects 70-71, wherein the downlink reference signal is configured in an active serving cell of the UE.
Aspect 73: The method of any of Aspects 70-72, wherein the downlink reference signal is configured in the candidate cell.
Aspect 74: The method of any of Aspects 70-73, wherein determining the downlink reference timing comprises: determining the downlink reference timing for the candidate cell based at least in part on receiving an indication to determine the uplink timing advance for the candidate cell.
Aspect 75: The method of any of Aspects 70-74, wherein determining the downlink reference timing comprises: determining the downlink reference timing for the candidate cell based at least in part on receiving a timing advance command.
Aspect 76: The method of any of Aspects 70-75, wherein determining the uplink timing advance for the candidate cell comprises: determining the uplink timing advance for the candidate cell prior to handover of the UE to the candidate cell.
Aspect 77: An apparatus for wireless communication at a device, comprising one or more memories and one or more processors, coupled to the one or more memories, which, individually or in any combination, are operable to cause the apparatus to perform the method of one or more of Aspects 1-76.
Aspect 78: A device for wireless communication, comprising one or more memories and one or more processors coupled to the one or more memories, the one or more processors configured to perform the method of one or more of Aspects 1-76.
Aspect 79: An apparatus for wireless communication, comprising at least one means for performing the method of one or more of Aspects 1-76.
Aspect 80: A non-transitory computer-readable medium storing code for wireless communication, the code comprising instructions executable by one or more processors to perform the method of one or more of Aspects 1-76.
Aspect 81: A non-transitory computer-readable medium storing a set of instructions for wireless communication, the set of instructions comprising one or more instructions that, when executed by one or more processors of a device, cause the device to perform the method of one or more of Aspects 1-76.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
one or more memories; and
one or more processors, coupled to the one or more memories, which, individually or in any combination, are operable to cause the apparatus to:
receive a timing advance (TA) indication associated with a candidate serving cell configured for layer 1/layer 2 (L1/L2) mobility;
receive, with the TA indication, an L1 message or an L2 message instructing the UE to switch to the candidate serving cell; and
communicate with the candidate serving cell based on the L1 message or the L2 message.

2. The apparatus of claim 1, wherein the TA indication comprises a medium access control layer control element.

3. The apparatus of claim 1, wherein the L2 message comprises a medium access control layer control element.

4. The apparatus of claim 1, wherein the L1 message comprises downlink control information.

5. The apparatus of claim 1, wherein the one or more processors are further configured to:
receive a random access channel (RACH) trigger or a sounding reference signal (SRS) trigger;
transmit a RACH preamble or an SRS to the candidate serving cell based on the RACH trigger or the SRS trigger; and
receive a handover command after transmitting the RACH preamble or the SRS.

6. The apparatus of claim 5, wherein the TA indication is included in the handover command.

7. The apparatus of claim 1, wherein the TA indication includes a TA identifier associated with a TA group (TAG) that includes the candidate serving cell.

8. The apparatus of claim 7, wherein the TAG is associated with a transmission configuration indicator state associated with the candidate serving cell.

9. The apparatus of claim 7, wherein the TAG is associated with at least one reference signal associated with the candidate serving cell.

10. The apparatus of claim 7, wherein the TAG is a primary TAG associated with the candidate serving cell.

11. An apparatus for wireless communication at a network node, comprising:
one or more memories; and
one or more processors, coupled to the one or more memories, which, individually or in any combination, are operable to cause the apparatus to:
transmit a timing advance (TA) indication associated with a candidate serving cell configured for Layer 1/Layer 2 (L1/L2) mobility; and
transmit, with the TA indication, an L1 message or an L2 message instructing a user equipment (UE) to switch to the candidate serving cell.

12. The apparatus of claim 11, wherein the TA indication comprises a medium access control layer control element.

13. The apparatus of claim 11, wherein the L2 message comprises a medium access control layer control element.

14. The apparatus of claim 11, wherein the L1 message comprises downlink control information.

15. The apparatus of claim 11, wherein the one or more processors are further configured to: transmit a random access channel (RACH) trigger or a sounding reference signal (SRS) trigger; and
transmit a handover command after transmitting the RACH trigger or the SRS trigger.

16. (canceled)

17. The apparatus of claim 11, wherein the TA indication includes a TA identifier associated with a TA group (TAG) that includes the candidate serving cell.

18. The apparatus of claim 17, wherein the TAG is associated with a transmission configuration indicator state associated with the candidate serving cell.

19. The apparatus of claim 17, wherein the TAG is associated with at least one reference signal associated with the candidate serving cell.

20. The apparatus of claim 17, wherein the TAG is a primary TAG associated with the candidate serving cell.

21. A method of wireless communication performed by a user equipment (UE), comprising:
receiving a timing advance (TA) indication associated with a candidate serving cell configured for layer 1/layer 2 (L1/L2) mobility; receiving, with the TA indication, an L1 message or an L2 message instructing the UE to switch to the candidate serving cell; and
communicating with the candidate serving cell based on the L1 message or the L2 message.

22-40. (canceled)
